(19) United States
(12) Patent Application Publication
(10) Pub. No.: US 2020/0133836 A1
(43) Pub. Date: Apr. 30, 2020

(54) DATA MANAGEMENT APPARATUS, DATA MANAGEMENT METHOD, AND DATA MANAGEMENT PROGRAM

(71) Applicant: Hitachi, Ltd., Tokyo (JP)

(72) Inventors: Nagamasa MIZUSHIMA, Tokyo (JP); Sadahiro SUGIMOTO, Tokyo (JP); Kentaro SHIMADA, Tokyo (JP)

(21) Appl. No.: 16/535,555

(22) Filed: Aug. 8, 2019

(30) Foreign Application Priority Data
Oct. 30, 2018 (JP) 2018-203851

(51) Int. Cl. G06F 12/02; G06F 12/06; G06F 3/06

(52) U.S. Cl. CPC G06F 12/0246; G06F 12/063; G06F 3/0622; G06F 3/0679; G06F 3/0652

(57) ABSTRACT

A storage system includes: a memory for caching of data according to input and output to a storage device; and a CPU connected to the memory. The memory includes: a DRAM high in access performance; and an SCM identical in a unit of access to the DRAM, the SCM being lower in access performance than the DRAM. The CPU determines whether to perform caching to the DRAM or the SCM, based on the data according to input and output to the storage device, and caches the data into the DRAM or the SCM, based on the determination.

### CROSS-REFERENCE TO RELATED APPLICATION

The present application claims priority from Japanese application JP 2018-203851, filed on Oct. 30, 2018, the contents of which is hereby incorporated by reference into this application.

### BACKGROUND OF THE INVENTION

### 1. Field of the Invention

The present invention relates to a technology of cache control of data.

### 2. Description of the Related Art

As an exemplary memory, a NAND flash memory that is a semiconductor nonvolatile memory, has been known. Such a NAND flash memory can be made higher in storage density and lower in cost per capacity (bit cost) than a volatile memory, such as a DRAM. [0003]

However, such a flash memory has the following limitations. Before rewriting of data, data erasing requires performing in units of blocks large in size, such as 4 MB. Reading and writing of data requires performing in units of pages. Each block includes a plurality of pages each having, for example, a size of 8 KB or 16 KB. Furthermore, there is an upper limit (rewriting lifespan) to the number of times of erasing in blocks. For example, the upper limit is approximately several thousand times.

Because the NAND flash memory has the advantage of being low in cost, has been disclosed a storage system equipped with a cache memory including the NAND flash memory as a medium, in addition to a cache memory including the DRAM as a medium (e.g., refer to WO 2014/103489 A).

For such a storage system, if data to be rewritten in small units, such as 8 B or 16 B, (e.g., management data) is stored in the cache memory including the NAND flash memory as a medium, data not to be updated accounting for 99% or more of pages requires simultaneous rewriting. Because the NAND flash memory has a short rewriting lifespan, such usage causes the lifespan to shorten. In contrast to this, WO 2014/103489 A discloses a technology of storing management data preferentially into the cache memory including the DRAM as a medium.

Meanwhile, as a semiconductor nonvolatile memory different from the NAND flash memory, a nonvolatile semiconductor memory called a storage class memory (SCM), such as a phase-change random access memory, a magnetoresistive random access memory, or a resistive random access memory, has been developed recently. The SCM is higher in storage density than the DRAM. The SCM is easy to manage because of no data erasing required differently from the NAND flash memory, accessibility in units of bytes similarly to the DRAM, and a long rewriting lifespan. The SCM lower in cost than the DRAM, is available as a larger-capacity memory at the same cost. However, as a feature, the SCM is generally lower in access performance than the DRAM.

### SUMMARY OF THE INVENTION

For improvement of read/write performance to user data in the storage system, reduction of the frequency of reading and writing of management data for management of the user data, from and in a disk is effective. Thus, the management data requires cashing in a memory as much as possible. For example, caching the management data into the DRAM causes a drawback that a rise occurs in system cost.

Caching not only the management data but also other data into the DRAM causes a drawback that a rise occurs in system cost. Meanwhile, caching to the flash memory causes a drawback that the lifespan of the flash memory shortens and a drawback that the access performance deteriorates.

The present invention has been made in consideration of the circumstances, and an objective of the present invention is to provide a technology enabling access performance to be relatively enhanced easily and properly.

In order to achieve the object, a data management apparatus according to one aspect includes: a memory unit for caching of data according to input and output to a storage device; and a processor unit connected to the memory unit, in which the memory unit includes: a first type of memory high in access performance; and a second type of memory identical in a unit of access to the first type of memory, the second type of memory being lower in access performance than the first type of memory, and the processor unit determines whether to perform caching to the first type of memory or the second type of memory, based on the data according to input and output to the storage device, and caches the data into the first type of memory or the second type of memory, based on the determination.

According to an embodiment of the present invention, access performance can be relatively enhanced easily and properly.

### BRIEF DESCRIPTION OF THE DRAWINGS

FIG. 1 is a diagram of an exemplary first configuration of an information system according to an embodiment;

FIG. 2 is a diagram of an exemplary second configuration of the information system according to the embodiment;

FIG. 3 is a table of the comparison in feature between memory media;

FIG. 4 is a diagram of the configuration of a DRAM in a storage controller according to the embodiment;

FIG. 5 is a diagram of the configuration of an SCM in the storage controller according to the embodiment;

FIG. 6 is a diagram of an outline of caching destination selection processing according to the embodiment;

FIG. 7 is a diagram of the relationship between a logical volume, a slot, and a segment according to the embodiment;

FIG. 8 is a diagram of the structure of cache management data according to the embodiment;

FIG. 9 is a diagram of the data structure of part of the cache management data according to the embodiment;

FIG. 10 is a diagram of the data structure of a dirty queue and a clean queue according to the embodiment;

FIG. 11 is a diagram of the data structure of an SCM free queue and a DRAM free queue according to the embodiment;

FIG. 12 is a diagram of the correspondence relationship between logical addresses in compression mode according to the embodiment;

FIG. 13 is a diagram of a management data structure in the compression mode according to the embodiment;

FIG. 14 is a flowchart of read command processing according to the embodiment;

FIG. 15 is a flowchart of user data read processing according to the embodiment;

FIG. 16 is a flowchart of segment allocation processing according to the embodiment;

FIG. 17 is a flowchart of SCM-priority segment allocation processing according to the embodiment;

FIG. 18 is a flowchart of DRAM-priority segment allocation processing according to the embodiment;

FIG. 19 is a flowchart of staging processing according to the embodiment;

FIG. 20 is a flowchart of data transmission processing according to the embodiment;

FIG. 21 is a flowchart of write command processing according to the embodiment;

FIG. 22 is a flowchart of user data write processing according to the embodiment;

FIG. 23 is a flowchart of management data access processing according to the embodiment;

FIG. 24 is a flowchart of dirty data export processing according to the embodiment; and

FIG. 25 is a flowchart of destaging processing according to the embodiment.

### DESCRIPTION OF THE PREFERRED EMBODIMENTS

An embodiment will be described with reference to the drawings. Note that the invention according to the scope of the claims is not limited to the embodiment to be described below, and all of the various elements and any combination thereof described in the embodiment are not necessarily essential for the invention.

Note that, in some cases, information is described with, for example, the expression “aaa table” in the following description. However, the information is not necessarily expressed by a data structure, such as a table. Thus, for independence of the data structure, for example, the “aaa table” can be called “aaa information”.

In some cases, a “program” is described as the subject in operation in the following description. Because the program is executed by a control device including a processor (typically, a central processing unit (CPU)) to perform determined processing with a memory and an interface (I/F), the processor or the control device may be described as the subject in operation. The control device may be the processor or may include the processor and a hardware circuit. Processing disclosed with the program as the subject in operation may be performed by a host computing machine or a storage system. The entirety or part of the program may be achieved by dedicated hardware. Various programs may be installed on each computing machine by a program distribution server or a computing-machine-readable storage medium. Examples of the storage medium may include an IC card, an SD card, and a DVD.

A “memory unit” includes one memory or more in the following description. At least one memory may be a volatile memory or nonvolatile memory.

A “processor unit” includes one processor or more in the following description. At least one processor is typically a microprocessor, such as a central processing unit (CPU). Each of the one processor or more may include a single core or a multi-core. Each processor may include a hardware circuit that performs the entirety or part of processing.

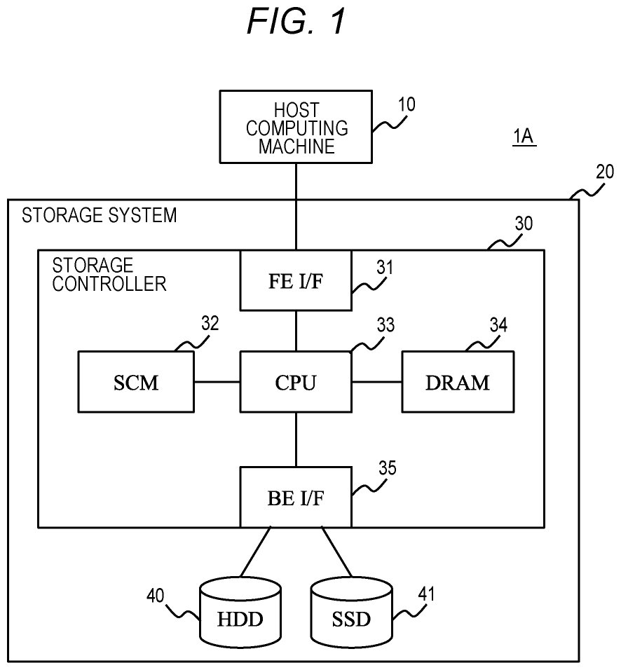

FIG. 1 is a diagram of an exemplary first configuration of an information system according to the embodiment.

The information system 1A includes a host computing machine 10 and a storage system 20 (exemplary data management apparatus) connected to the host computing machine 10 directly or through a network. The storage system 20 includes a storage controller 30 and a hard disk drive 40 (HDD) and/or a solid state drive (SSD) 41 connected to the storage controller 30. The HDD 40 and/or the SSD 41 is an exemplary storage device. The HDD 40 and/or the SSD 41 may be built in the storage controller 30.

The storage controller 30 includes a front-end interface (FE I/F) 31, a back-end interface (BE I/F) 35, a storage class memory (SCM) 32, a CPU 33, and a dynamic random access memory (DRAM) 34. The SCM 32 and the DRAM 34 each are a memory (memory device) readable and writable in units of bytes, in which a unit of access is a unit of byte. Here, the DRAM 34 corresponds to a first type of memory, and the SCM 32 corresponds to a second type of memory. The DRAM 34 and the SCM 32 correspond to a memory unit.

The storage controller 30 forms one logical volume or more (actual logical volume) from the plurality of storage devices (HDD 40 and SSD 41), and supplies the host computing machine 10 with the one logical volume or more. That is the storage controller 30 enables the host computing machine 10 to recognize the formed logical volume. Alternatively, the storage controller 30 supplies the host computing machine 10 with a logical volume formed by so-called thin provisioning (virtual logical volume including areas to which a storage area is allocated dynamically).

The host computing machine 10 issues an I/O command (write command or read command) specifying the logical volume to be supplied from the storage system 20 (actual logical volume or virtual logical volume) and a position in the logical volume (logical block address for which “LBA” is an abbreviation), and performs read/write processing of data to the logical volume. Note that the present invention is effective even for a configuration in which the storage controller 30 supplies no logical volume, for example, a configuration in which the storage system 20 supplies the host computing machine 10 with each of the HDD 40 and the SSD 41 as a single storage device. Note that the logical volume that the host computing machine 10 recognizes is also called a logical unit (for which “LU” is an abbreviation). Thus, unless otherwise noted in the present specification, the term “logical volume” and the term “logical unit (LU)” both are used as an identical concept.

The FE I/F 31 is an interface device that communicates with the host computing machine 10. The BE I/F 35 is an interface device that communicates with the HDD 40 or the SSD 41. For example, the BE I/F 35 is an interface device for SAS or Fibre Channel.

The CPU 33 performs various types of processing to be described later. The DRAM 34 stores a program to be executed by the CPU 33, control information and buffer data to be used by the CPU 33. Examples of the SCM 32 include a phase-change random access memory, a magnetoresistive random access memory, and a resistive random access memory. The SCM 32 stores data. The SCM 32 and DRAM 34 each include a cache memory area. The cache memory area includes a plurality of cache segments. A cache segment is a unit area that the CPU 33 manages. For example, area securing, data reading, and data writing may be performed in units of cache segments in the cache memory area. Data read from the final storage device and data to be written in the final storage device (user data that is data obeying the I/O command from the host computing machine 10 (typically, write command or read command)) are cached in the cache memory area (temporarily stored). The final storage device stores data to which the storage controller 30 performs I/O in accordance with the I/O destination specified by the I/O command. Specifically, for example, the data obeying the I/O command (write command) is temporarily stored in the cache memory area. After that, the data is stored in the area of the storage device included in the logical unit (logical volume) specified by the I/O command (area of the storage device allocated to the area of the logical volume in a case where the logical volume is virtual). The final storage device means a storage device that forms the logical volume. According to the present embodiment, although the final storage device is the HDD 40 or the SSD 41, the final storage device may be a different type of storage device, for example, an external storage system including a plurality of storage devices.

Management data is cached in the cache memory area. For example, the management data is used by the storage system 20 for management of data portions divided from the user data in predetermined units, the management data being small-size data corresponding to each data portion. The management data is used only inside the storage system 20, and is not read and written from the host computing machine 10. Similarly to the user data, the management data is saved in the final storage device.

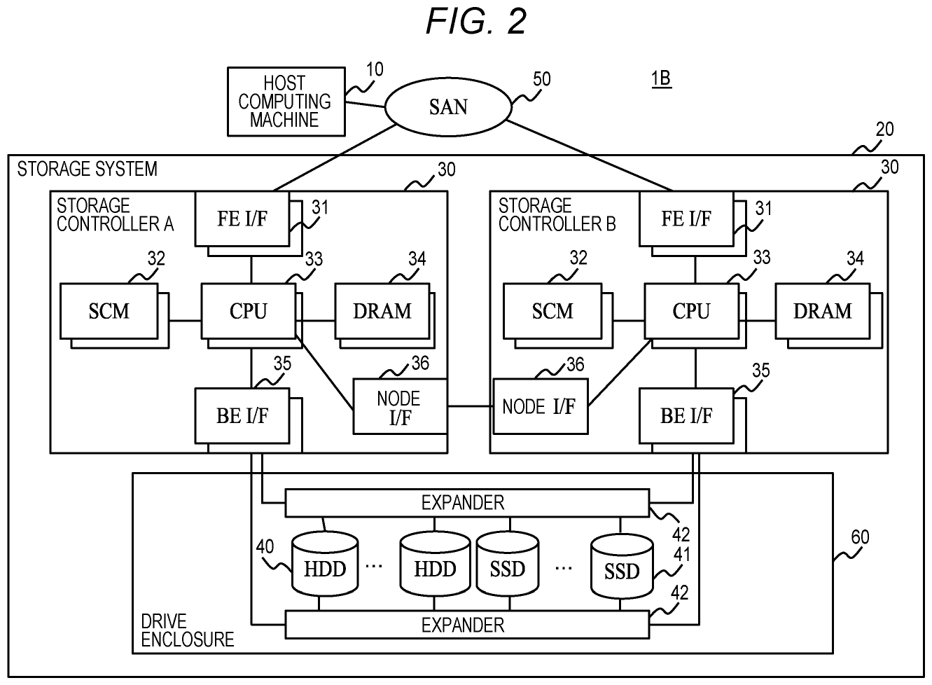

The information system 1A of FIG. 1 includes one of each constituent element, but may include at least two of each constituent element for redundancy, high performance, or large capacity. Connection may be made between each constituent element through a network. The network may include a switch and an expander. In consideration of redundancy and high performance, for example, the information system may have a configuration illustrated in FIG. 2.

FIG. 2 is a diagram of an exemplary second configuration of the information system according to the embodiment.

The information system 1B includes a host computing machine 10, a storage system 20, and a network 50 connecting the host computing machine 10 and the storage system 20. The network 50 may be, for example, Fibre Channel, Ethernet, or Infiniband. In the present embodiment, the network 50 is generically called a storage area network (SAN).

The storage system 20 includes two storage controllers 30 (storage controller A and storage controller B) and a drive enclosure 60.

The storage controllers 30 each include a plurality of FE I/Fs 31, a plurality of BE I/Fs 35, a plurality of SCMs 32, a plurality of CPUs 33, a plurality of DRAMs 34, and a node interface (node I/F) 36. For example, the node interface 36 may be a network interface device for Infiniband, Fibre Channel (FC), or Ethernet (registered trademark), or may be a bus interface device for PCI Express. The two storage controllers 30 are connected through the respective node interfaces 36. Here, each DRAM 34 corresponds to a first type of memory, and each SCM 32 corresponds to a second type of memory. The DRAMs 34 and the SCMs 32 correspond to a memory unit.

The drive enclosure 60 stores a plurality of HDDs 40 and a plurality of SSDs 41. The plurality of HDDs 40 and the plurality of SSDs 41 are connected to expanders 42 in the drive enclosure 60. Each expander 42 is connected to the BE I/Fs 35 of each storage controller 30. In a case where each BE I/F 35 is an interface device for SAS, each expander 42 is, for example, a SAS expander. In a case where each BE I/F 35 is an interface device for Fibre Channel, each expander 42 is, for example, an FC switch.

Note that the storage system 20 includes one drive enclosure 60, but may include a plurality of drive enclosures 60. In this case, each drive enclosure 60 may be directly connected to the respective ports of the BE I/Fs 35. Alternatively, the plurality of drive enclosures 60 may be connected to the ports of the BE I/Fs 35 through a switch. The plurality of drive enclosures 60 strung by cascade connection between the respective expanders 42 of the drive enclosures 60, may be connected to the ports of the BE I/Fs 35.

Next, the features of memory media will be described.

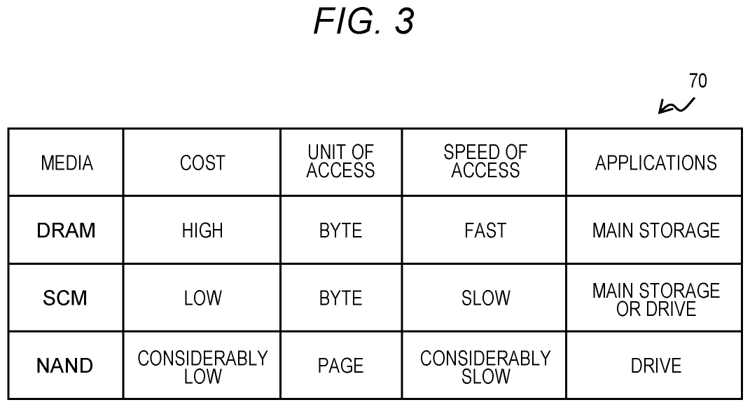

FIG. 3 is a table of the comparison in feature between memory media.

Characteristically, the DRAM is considerably high in access performance, readable and writable in units of bytes, and volatile. Thus, the DRAM is generally used as a main storage device or a buffer memory. Note that, because the DRAM is high in bit cost, there is a disadvantage that a system equipped with a large number of DRAMs is high in cost.

Examples of the SCM include a phase-change random access memory (PRAM), a magnetoresistive random access memory (MRAM), and a resistive random access memory (ReRAM). Characteristically, the SCM is lower in access performance than the DRAM, but is lower in bit cost than the DRAM. Similarly to the DRAM, the SCM is readable and writable in units of bytes. Thus, in the allowable range of access performance, the SCM can be used, instead of the DRAM, as a main storage device or a buffer memory. Thus, in consideration of the allowable amount of mounting on an information system at the same cost, advantageously, the SCM is larger than the DRAM. Because of non-volatility, the SCM can be used as a medium for a drive.

The NAND is a NAND flash memory. Characteristically, the NAND is lower in access performance than the SCM, but is lower in bit cost than the SCM. Differently from the DRAM and the SCM, the NAND requires reading and writing in units of pages each considerably larger than a byte. The size of a page is, for example, 8 KB or 16 KB. Before rewriting, erasing is required. A unit of erasing is the aggregate size of a plurality of pages (e.g., 4 MB). Because the NAND is considerably low in bit cost and is nonvolatile, the NAND is mainly used as a medium for a drive. There is a drawback that the rewriting lifespan of the NAND is short.

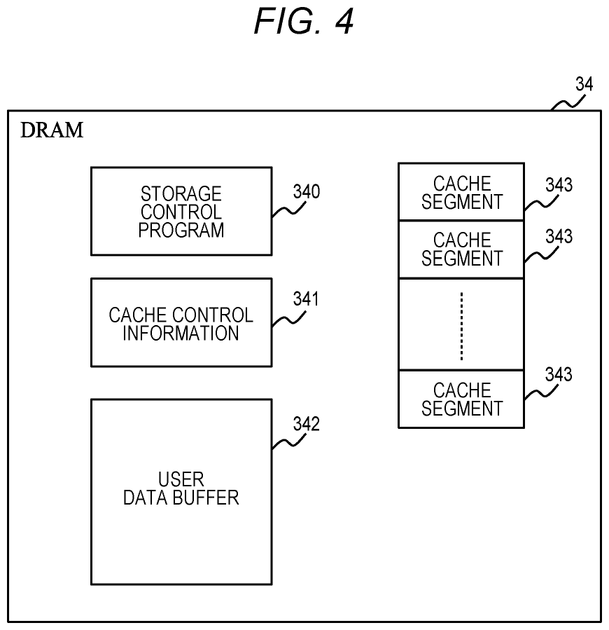

FIG. 4 is a diagram of the configuration of the DRAM of the storage controller according to the embodiment.

The DRAM 34 stores a storage control program 340 to be executed by the CPU 33, cache control information 341, and a user data buffer 342. The DRAM 34 stores a plurality of cache segments 343 for caching and management of data. The user data and the management data to be stored in the HDD 40 or the SSD 41 or the user data and the management data read from the HDD 40 or the SSD 41 are cached in the cache segments 343.

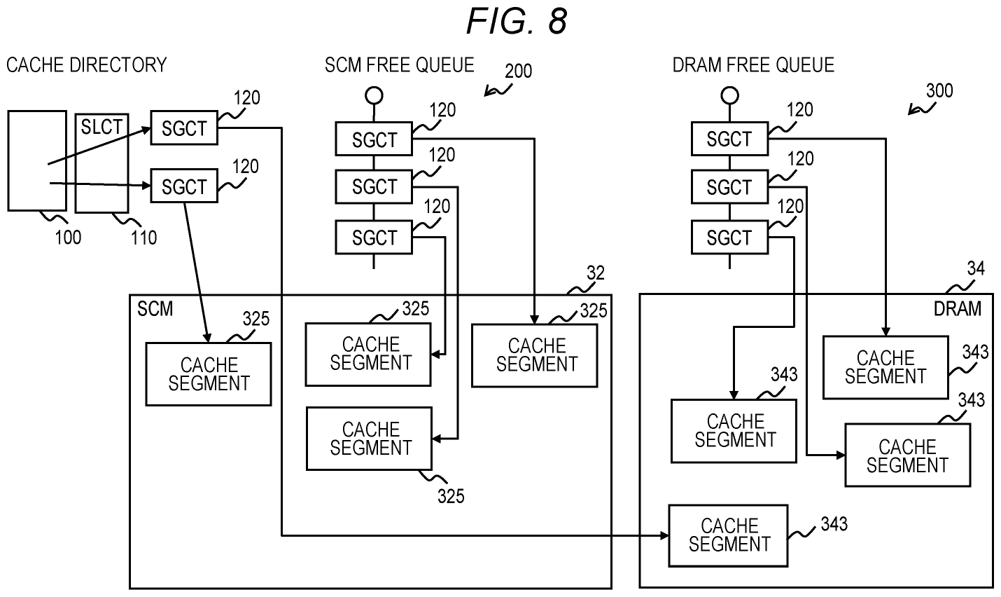

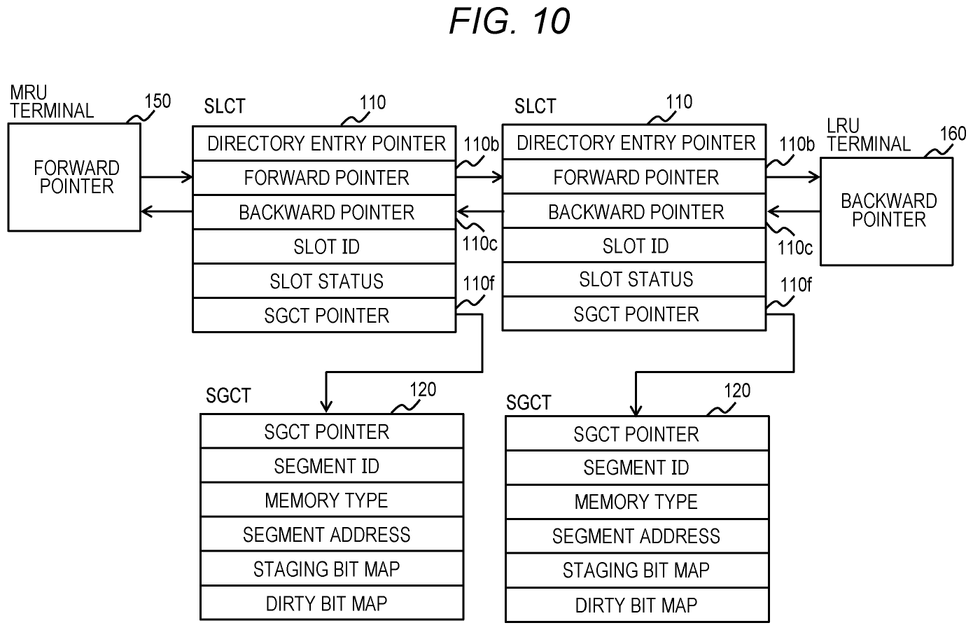

The storage control program 340 that is an exemplary data management program, causes performance of various types of control processing for caching. Note that the details of the processing will be described later. The cache control information 341 includes a cache directory 100 (refer to FIG. 8), a clean queue (refer to FIG. 10), a dirty queue (refer to FIG. 10), an SCM free queue 200 (refer to FIG. 8), and a DRAM free queue 300 (refer to FIG. 8). A data structure for the cache control information 341, will be described later.

As a method of implementing the DRAM 34, for example, a memory module, such as a DIMM including the memory chips of a plurality of DRAMs mounted on a substrate, may be prepared and then may be connected to a memory slot on the main substrate of the storage controller 30. Note that mounting the DRAM 34 on a substrate different from the main substrate of the storage controller 30, enables maintenance replacement or DRAM capacity expansion, independently of the main substrate of the storage controller 30. For prevention of the stored contents on the DRAM 34 from being lost due to accidental failure, such as a power failure, a battery may be provided so as to retain the stored contents on the DRAM 34 even at a power failure.

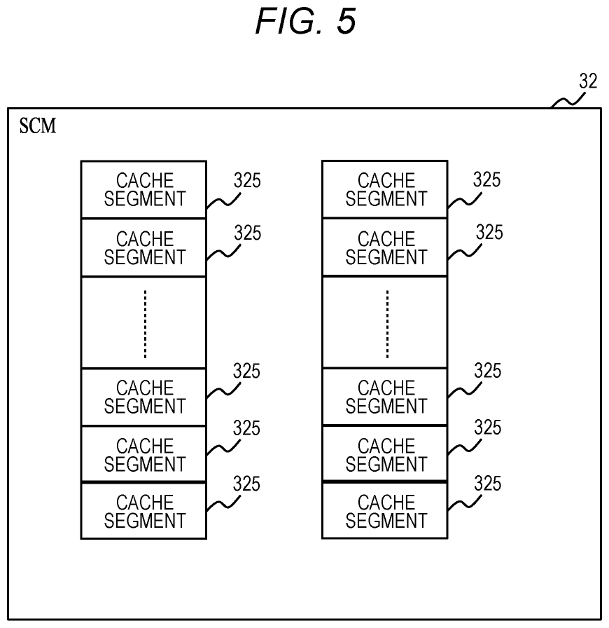

FIG. 5 is a diagram of the configuration of the SCM of the storage controller according to the embodiment.

The SCM 32 stores a plurality of cache segments 325 for caching and management of data. The user data and the management data to be stored in the HDD 40 or the SSD 41 or the user data and the management data read from the HDD 40 or the SSD 41 can be cached in the cache segments 325.

Next, an outline of caching destination selection processing will be described, in which the storage system according to the present embodiment selects a caching destination for data.

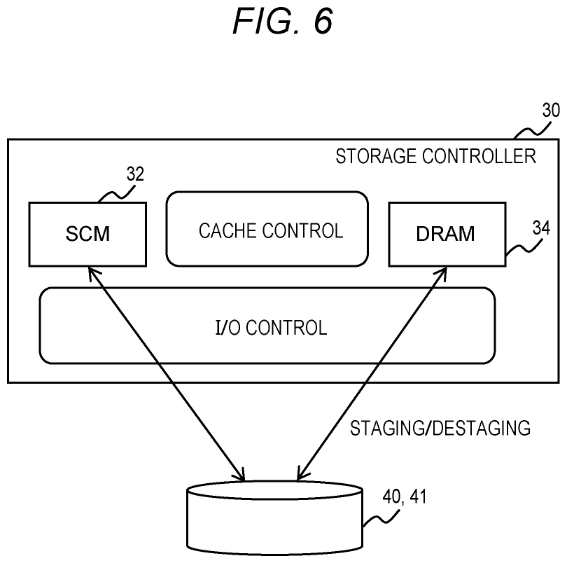

FIG. 6 is a diagram of the outline of caching destination selection processing according to the embodiment.

The storage controller 30 of the storage system 20 caches data managed in the HDD 40 or the SSD 41 into either the SCM 32 or the DRAM 34. The storage controller 30 determines the caching destination of the data, on the basis of the type of the data to be cached (cache target data). Specific caching destination selection processing (segment allocation processing) will be described later.

Next, before description of the structure of cache management data for management of caching, an outline of the relationship between a volume (logical volume) and the cache management data will be described.

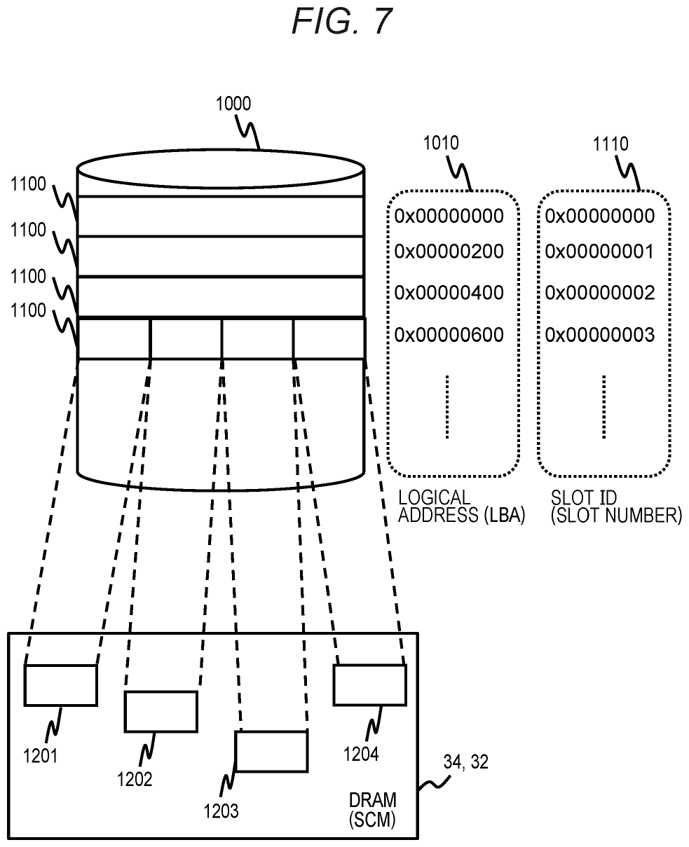

FIG. 7 is a diagram of the relationship between a logical volume, a slot, and a segment according to the embodiment.

The HDD 40 or the SSD 41 stores a logical volume 1000 to be accessed by the host computing machine 10. When the host computing machine 10 accesses the logical volume 1000, a minimum unit of access is a block (e.g., 512 bytes). Each block of the logical volume 1000 can be identified with a logical block address (LBA, also called a logical address). For example, the logical address to each block can be expressed as indicated in logical address 1010.

In the storage system 20, exclusive control is performed at access to a storage area on the logical volume. As a unit of exclusive control, a slot 1100 is defined. The size of the slot 1100 is, for example, 256 KB covering, for example, 512 blocks. Note that the size of the slot 1100 is not limited to this, and thus may be different.

Each slot 1100 can be identified with a unique identification number (slot ID). The slot ID can be expressed, for example, as indicated in slot ID 1110. In FIG. 7, each logical address in the logical address 1010 indicates the logical address of the front block in the slot corresponding to each slot ID in the slot ID 1110.

According to the present embodiment, for example, a value acquired by dividing the logical block address specified by the I/O command received from the host computing machine 10, by 512 is the slot ID of the slot to which the block corresponding to the logical block address belongs. In a case where the remainder is zero after the division, the block specified with the logical block address specified by the I/O command indicates the front block in the slot specified with the calculated slot ID. In a case where the remainder is a value that is not zero (here, the value is defined as R), the R indicates that the block specified with the logical block address is the block at the R-th position from the front block in the slot specified with the calculated slot ID. (here, the R is called an in-slot relative address).

For caching of data on the logical volume 1000, the storage controller 30 secures a storage area on the DRAM 34 or the SCM 32 as a cache area. The storage controller 30 secures the cache area in units of areas of cache segments (segments) 1201, 1202, 1203, and 1204 (hereinafter, “cache segment 1200” is used as the generic term for the cache segments 1201, 1202, 1203, and 1204). According to the present embodiment, for example, the size of a cache segment 1200 is 64 KB, and four cache segments 1200 (e.g., 1201, 1202, 1203, and 1204) are associated with each slot.

As information for management of the slots 1100, the storage system 20 has a slot control table 110 for each slot 1100 (refer to FIG. 8). The slot control table 110 stores information regarding the cache segments 1200 associated with the slot 1100 (specifically, a pointer to information for management of the cache segments 1200). The storage system 20 creates and manages the slot control table 110, to manage the association between the slot 1100 and the cache segments 1200. Note that the size of a cache segment 1200 may be different from 64 KB, and the number of cache segments 1200 to be associated with one slot 1100 may be different from four.

Next, an outline of processing related to management of the cache area at access from the host computing machine 10 to an area on the logical volume 1000 (e.g., read or write), will be described.

At access to the user data, the host computing machine 10 issues an I/O command specifying the logical unit number (LUN) of the access destination (number specifying the logical unit/logical volume) and the logical block address 1010, to the storage system 20. The storage controller 30 of the storage system 20 converts the logical block address included in the received I/O command, into a set of the slot ID 1110 and the in-slot relative address, and refers to the slot control table 110 specified with the slot ID 1110 acquired by the conversion. Then, on the basis of the information in the slot control table 110, the storage controller 30 determines whether the cache segment 1200 has been secured to the area on the logical volume 1000 specified by the I/O command (area specified with the logical block address). In a case where the cache segment 1200 has not been secured yet, the storage controller 30 performs processing of securing the cache segment 1200 newly.

Next, the structure of the cache management data will be described.

FIG. 8 is a diagram of the structure of the cache management data according to the embodiment.

The cache management data includes the cache directory 100, the SCM free queue 200, the DRAM free queue 300, the dirty queue, and the clean queue (refer to FIG. 10). According to the present embodiment, cache segments 343 and 325 are managed in the DRAM 34 and the SCM 32, respectively. Each cache segment is managed with a segment control table (SGCT) 120. For management, the SGCT 120 has a one-to-one correspondence with each of all the cache segments managed in the DRAM 34 and the SCM 32.

The cache directory 100 is data for management of the correspondence relationship between the logical address of the cache target data (logical block address of the logical volume that is the storage destination of data stored in the cache segment) and respective physical addresses on the memories (DRAM 34 and SCM 32). The cache directory 100 is, for example, a hash table in which the slot ID to which the cache segment of the cache target data belongs (slot ID can be specified from the logical block address) is a key. The cache directory 100 stores, as an entry, a pointer to the slot control table (SLCT) 110 corresponding to the slot having the slot ID. The SLCT 110 manages a pointer to the SGCT 120 of the cache segment belonging to the slot. The SGCT 120 manages a pointer to the cache segment 325 or 343 corresponding to the SGCT 120.

Therefore, the cache directory 100 enables specification of the cache segment having cached the data corresponding to the logical address, based on the logical address of the cache target data. Note that the detailed configurations of the SLCT 110 and the SGCT 120 will be described later. According to the present embodiment, the cache directory 100 collectively manages all of the cache segments 343 of the DRAM 34 and the cache segments 325 of the SCM 32. Thus, reference to the cache directory 100 enables easy determination of a cache hit in the DRAM 34 and the SCM 32.

The SCM free queue 200 is control information for management of a free segment of the SCM 32, namely, the cache segment 325 storing no data. For example, the SCM free queue 200 is provided as a doubly linked list including, as an entry, the SGCT 120 corresponding to the free segment of the SCM 32. Note that the data structure of the control information for management of the free segment, is not necessarily a queue structure, and thus may be, for example, a stack structure.

The DRAM free queue 300 is control information for management of a free segment of the DRAM 34. For example, the DRAM free queue 300 is provided as a doubly linked list including, as an entry, the SGCT 120 corresponding to the free segment of the DRAM 34. Note that the data structure of the control information for management of the free segment, is not necessarily a queue structure, and thus may be, for example, a stack structure.

The SGCT 120 has a connection with any of the cache directory 100, the SCM free queue 200, and the DRAM free queue 300, depending on the state and the type of the cache segment corresponding to the SGCT 120. Specifically, the SGCT 120 corresponding to the cache segment 325 of the SCM 32 is connected to the SCM free queue 200 when the cache segment 325 is unoccupied. Allocation of the cache segment 325 for data storage causes the SGCT 120 to be connected to the cache directory 100. Meanwhile, the SGCT 120 corresponding to the cache segment 343 of the DRAM 34 is connected to the DRAM free queue 300 when the cache segment 343 is unoccupied. Allocation of the cache segment 343 for data storage causes the SGCT 120 to be connected to the cache directory 100.

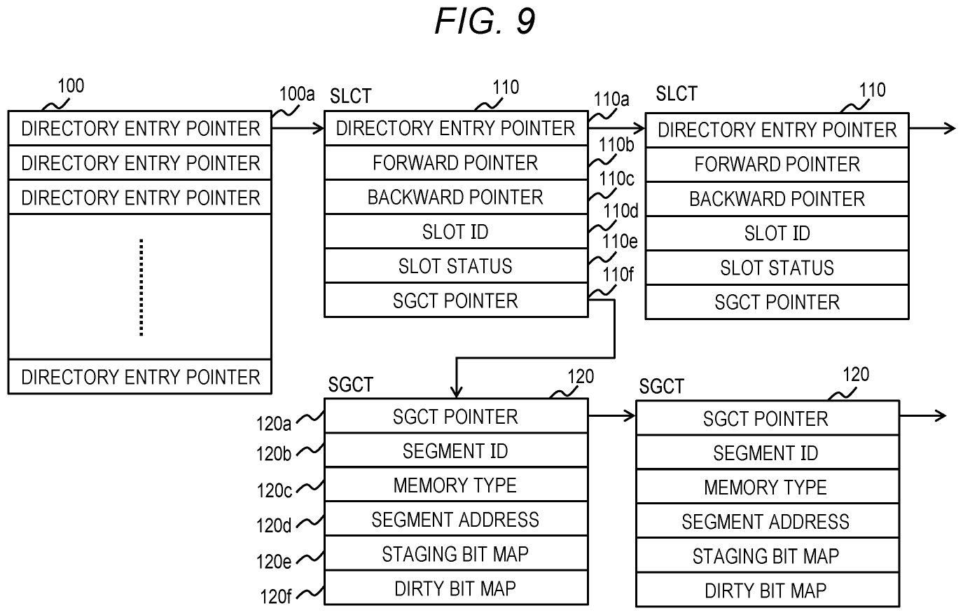

FIG. 9 is a diagram of the data structure of part of the cache management data according to the embodiment.

For example, the cache directory 100 is a hash table with the slot ID as a key. An entry (directory entry) 100a of the cache directory 100 stores a directory entry pointer indicating the SLCT 110 corresponding to the slot ID. Here, the slot is a unit of data for exclusive control (unit of locking). For example, one slot can include a plurality of cache segments. Note that, in a case where only part of the slot is occupied with data, there is a possibility that the slot includes only one cache segment.

The SLCT 110 includes a directory entry pointer 110a, a forward pointer 110b, a backward pointer 110c, slot ID 110d, slot status 110e, and a SGCT pointer 110f. The directory entry pointer 110a indicates the SLCT 110 corresponding to a different key with the same hash value. The forward pointer 110b indicates the previous SLCT 110 in the clean queue or the dirty queue. The backward pointer 110c indicates the next SLCT 110 in the clean queue or the dirty queue. The slot ID 110d is identification information (slot ID) regarding the slot corresponding to the SLCT 110. The slot status 110e is information indicating the state of the slot. As the state of the slot, for example, provided is “Being locked” indicating that the slot has been locked. The SGCT pointer 110f indicates the SGCT 120 corresponding to the cache segment included in the slot. When no cache segment has been allocated to the slot, the SGCT pointer 110f has a value indicating that the pointer (address) is invalid (e.g., NULL). In a case where a plurality of cache segments is included in the slot, the SGCTs 120 are managed as a linked list. The SGCT pointer 110f indicates the SGCT 120 corresponding to the front cache segment on the linked list.

The SGCT 120 includes an SGCT pointer 120a, segment ID 120b, memory type 120c, segment address 120d, staging bit map 120e, and dirty bit map 120f.

The SGCT pointer 120a indicates the SGCT 120 corresponding to the next cache segment included in the same slot. The segment ID 120b that is identification information regarding the cache segment, indicates what number the cache segment is in the slot. According to the present embodiment, because four cache segments are allocated to one slot at the maximum, any value of 0, 1, 2, and 3 is stored into the segment ID 120b of each cache segment. The segment ID 120b of the cache segment at the front in the slot is 0, and the following cache segments are given 1, 2, and 3 in this order as the segment ID 120b. For example, for the cache segments 1201 to 1204 in FIG. 7, the segment ID 120b of the cache segment 1201 associated with the front in the slot 1100 is 0, and the respective segment IDs 120b of the cache segments 1202, 1203, and 1204 are 1, 2, and 3. The memory type 120c indicates the type of memory of the cache memory storing the cache segment corresponding to the SGCT 120. Examples of the type of memory include the SCM and the DRAM.

The segment address 120d indicates the address of the cache segment. The staging bit map 120e indicates the area in which clean data in the cache segment, namely, data identical to data in the drive 40 or 41 has been cached. In the staging bit map 120e, each bit corresponds to each area in the cache segment. The bit corresponding to the area in which valid data (data identical to data in the drive) has been cached, is set at ON (1), and the bit corresponding to the area in which no valid data has been cached, is set at OFF (0). The dirty bit map 120f indicates the area in which dirty data in the cache segment, namely, data non-identical to data in the drive (data having not been reflected in the drive) has been cached. In the dirty bit map 120f, each bit corresponds to each area in the cache segment. The bit corresponding to the area in which the dirty data has been cached, is set at ON (1), and the bit corresponding to the area in which no dirty data has been cached, is set at OFF (0).

FIG. 10 is a diagram of the data structure of the dirty queue and the clean queue according to the embodiment.

The dirty queue includes the SLCT 110 corresponding to the slot including the dirty data, in connection. The clean queue includes the SLCT 110 corresponding to the slot including only the clean data, in connection. For example, the dirty queue and the clean queue are used for scheduling of cache replacement or destaging, and have various structures, depending on a method of scheduling the cache replacement or the destaging.

According to the present embodiment, an algorithm for scheduling of the cache replacement and the destaging will be described as Least Recently Used (LRU). Note that the dirty queue and the clean queue are similar in basic queue configuration except for the SLCT 110 to be connected, and thus the description will be given with the dirty queue as an example.

The dirty queue is provided as a doubly linked list for the SLCT 110. That is the dirty queue connects a forward pointer of a Most Recently Used (MRU) terminal 150 with the SLCT 110 corresponding to the slot including the dirty data recently used (slot latest in end usage time) and connects the forward pointer 110b of the connected SLCT 110 with the SLCT 110 of the next slot (slot including the dirty data secondly recently used) for sequential connection of the SLCTs 110 in the usage order of the dirty data, and connects the forward pointer 110b of the last SCLT 110 with an LRU terminal 160. In addition, the dirty queue connects a backward pointer of the LRU terminal 160 with the last SCLT 110 and connects the backward pointer 110c of the connected last SCLT 110 with the SLCT 110 of the previous slot in sequence, and connects the first SLCT 110 with the MRU terminal 150. In the dirty queue, the SLCTs 110 are arranged from the MRU terminal 150 side in the latest order of end usage time.

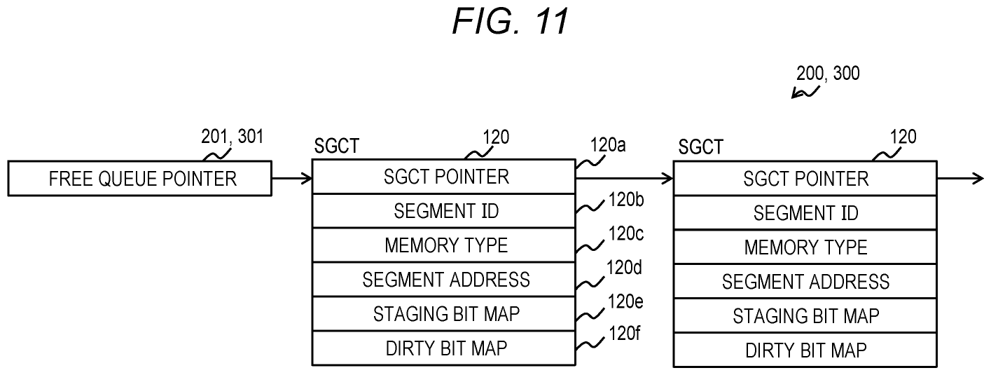

FIG. 11 is the data structure of the SCM free queue and the DRAM free queue according to the embodiment.

The SCM free queue 200 is intended for management of a free cache segment 325 stored in the SCM 32. The DRAM free queue 300 is intended for management of a free cache segment 343 in the DRAM 34. The SCM free queue 200 and the DRAM free queue 300 each are provided as a linked list including connection of the SGCT 120 of the free cache segment with a pointer. The SCM free queue 200 and the DRAM free queue 300 are identical in configuration except for the SGCT 120 to be managed.

A free queue pointer 201 (301) of the SCM free queue 200 (DRAM free queue 300) indicates the front SGCT 120 in the queue. The SGCT pointer 120a of the SGCT 120 indicates the SGCT 120 of the next free cache segment.

Next, the processing operation of the storage system 20 will be described.

The storage system 20 is capable of operating to compress and store the user data into the final storage device 40 or 41. Here, the state of the storage system 20 set so as to compress and store the user data, is called compression mode, and otherwise the state of the storage system 20 is called normal mode.

In the compression mode, in accordance with the write command, the storage system 20 processes the user data accepted from the host computing machine 10, with a lossless compression algorithm, to reduce the size of the user data, and then saves the user data in the final storage device. In accordance with the read command, the storage system 20 decompresses the user data compressed in the final storage device (compressed user data) (decompression), to produce the original user data, and transmits the original user data to the host computing machine 10.

The compression mode enables reduction in the amount of occupancy in the storage area of the final storage device, so that a larger amount of user data can be stored. Note that, because the CPU 33 compresses and decompresses the user data, generally, the compression mode is lower in processing performance than the normal mode.

Switching of the operation mode of the storage system 20 (e.g., switching from the compression mode to the normal mode or switching from the normal mode to the compression mode) can be performed by a mode setting command from the host computing machine 10 or by an management command through an I/F for management (not illustrated) in the storage system 20. The CPU 33 of the storage controller 30 switches the operation mode of the storage system 20 in accordance with the commands. The CPU 33 manages the mode set state (the compression mode or the normal mode).

Next, the logical address in the compression mode will be described.

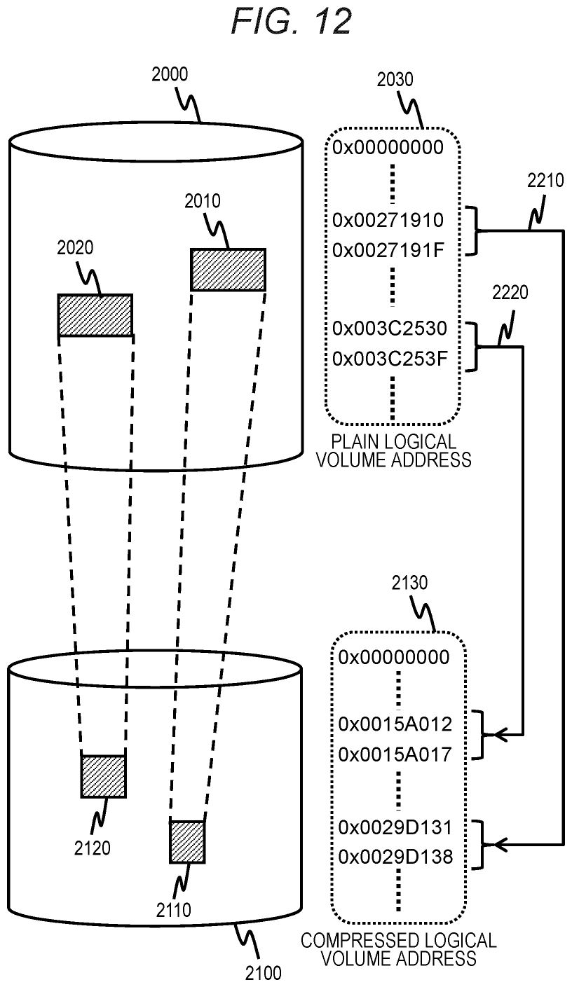

FIG. 12 is a diagram of the correspondence relationship between logical addresses in the compression mode according to the embodiment.

In the compression mode, the storage system 20 compresses and saves the user data input with the write command by the host computing machine 10, in the storage system 20. Meanwhile, the storage system 20 decompresses and outputs the user data requested with the read command by the host computing machine 10, in the storage system 20. Thus, the logical volume that the host computing machine 10 recognizes is the same as in the normal mode in which the user data is saved without compression. In the compression mode, such a logical volume is called a plain logical volume 2000. In contrast to this, a logical data area that the storage system 20 recognizes at saving of the compressed user data into the final storage device 40 or 41, is called a compressed logical volume 2100.

In the storage system 20, the CPU 33 divides the user data in the plain logical volume 2000 in units of predetermined management (e.g., 8 KB), and compresses the data in each unit of management for individual saving. After the compressed user data is saved in the compressed logical volume 2100, an address map is formed, indicating the correspondence relationship between addresses in data storage spaces of both of the logical volumes. That is, in a case where the host computing machine 10 writes the user data in address X in the plain logical volume 2000 and then the user data compressed is saved in address Y of the compressed logical volume 2100, the address map between X and Y is formed.

Compression causes the user data to vary in data length in accordance with the data content thereof. For example, inclusion of a large number of identical characters causes a reduction in data length, and inclusion of a large number of random-number patterns causes an increase in data length. Thus, information regarding address Y in the address map includes not only the front position of the save destination but also an effective data length from the position.

In FIG. 12, a user data portion 2010 with a size of 8 KB written to address 0x271910 in the plain logical volume 2000 by the host computing machine 10, is reduced to 4 KB in size by compression and then is saved in a range 2110 of 4 KB from address 0x29D131 in the compressed logical volume 2100. A user data portion 2020 with a size of 8 KB written to address 0x3C2530 in the plain logical volume 2000 by the host computing machine 10, is reduced to 3 KB in size by compression and then is saved in a range 2120 of 3KB from address 0x15A012 in the compressed logical volume 2100.

For compression and saving of the user data, arrangement of data with as no gap as possible enables reduction in the amount of occupancy in the storage area of the final storage device. Thus, the save destination of the compressed user data varies dynamically, depending on the order of writing from the host computing machine 10 or the relationship in size between compressed size and free area size. That is the address map varies dynamically, depending on writing of the user data.

In the example illustrated in FIG. 12, address maps 2210 and 2220 are formed between a plain logical volume address space 2030 and a compressed logical volume address space 2130. For example, the address map 2210 includes the address 0x29D131 of the range 2110 of the compressed logical volume 2100 and an effective data length of 4 KB. The address map 2220 includes the address 0x15A012 of the range 2120 in the compressed logical volume 2100 and an effective data length of 3 KB.

The address maps each are a small amount of auxiliary data necessary in each unit of management (here, 8 KB) divided from the user data for management of the save destination of the user data, and are called the management data. Similarly to the user data, the management data is saved in the final storage device 40 or 41.

Note that the user data that has been compressed is cached in the cache memory area of the SCM 32 or the DRAM 34. Therefore, the logical address at management of segment allocation in the cache area corresponds to the address on the compressed logical volume. The management data is cached in the cache memory area of the SCM 32 or the DRAM 34.

Next, the data structure of the management data and processing of changing address map information will be described.

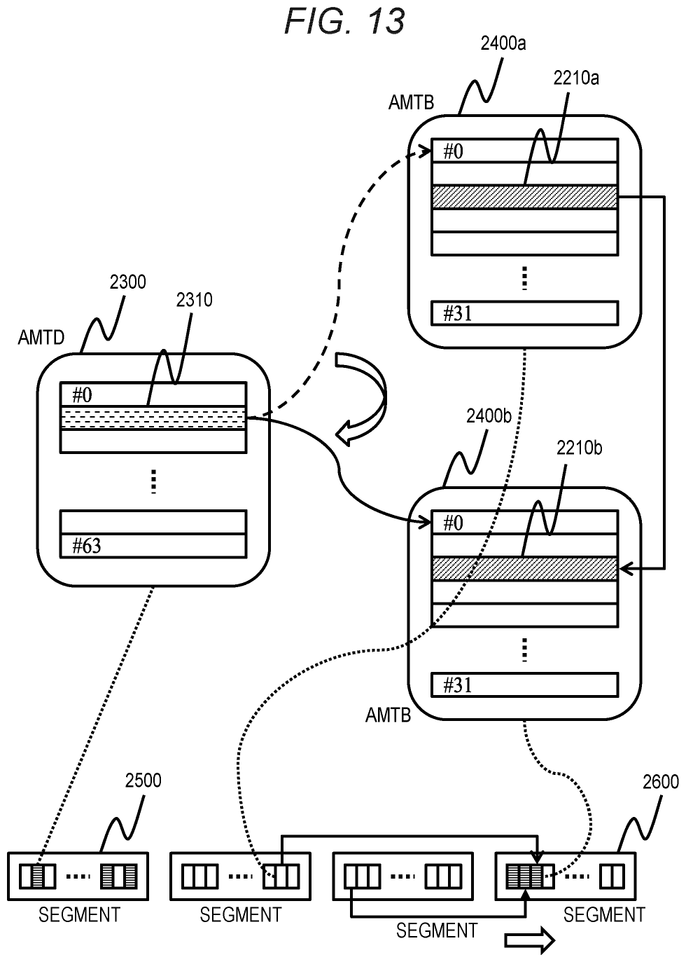

FIG. 13 is a diagram of the structure of the management data in the compression mode according to the embodiment.

The management data means the address map information between the plain logical volume and the compressed logical volume. According to the present embodiment, for the address map information 2210 (e.g., 2210a and 2210b), a unit of size is, for example, 16 B. Each address map table block (AMTB) 2400 (e.g., 2400a and 2400b) is a block for management of a plurality of pieces of address map information 2210. For example, each AMTB 2400 has a size of 512 B, in which 32 pieces of address map information 2210 can be stored. The storage order of the address map information 2210 in each AMTB 2400 is identical to the address order in the plain logical volume. Because one piece of address map information corresponds to 8 KB of user data, one AMTB 2400 enables management of 256 KB of user data including continuous logical addresses (namely, corresponding to one slot).

Each address map table directory (AMTD) 2300 is a block for management of the address (AMTB address) 2310 of the AMTB 2400. For example, each AMTD 2300 has a size of 512 B, in which 64 AMTB addresses 2310 each having a size of 8 B can be stored. The storage order of the AMTB address 2310 in each AMTD 2300 is identical to the slot-ID order in the plain logical volume. Because one AMTB 2400 corresponds to 256 KB of user data, one AMTD 2300 enables management of 16 MB of user data including continuous logical addresses.

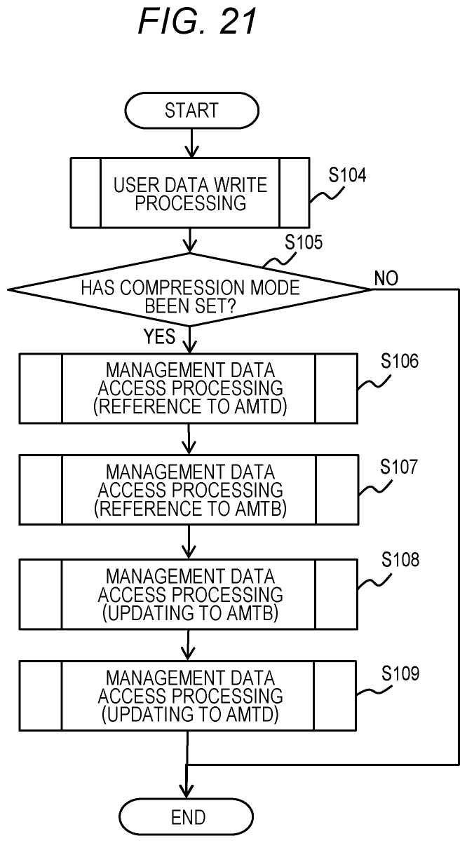

In the compression mode, changing of the address map information is performed in write command processing to be described later (refer to FIG. 21).

In a case where changing the content of address map information 2210a, the CPU 33 creates a new AMTB 2400b and writes address map information 2210b therein. Next, the CPU 33 copies different address map information not to be changed in an AMTB 2400a including the address map information 2210a, into the remaining portion of the AMTB 2400b. Then, the CPU 33 rewrites the AMTB address 2310 indicating the AMTB 2400a in the AMTD 2300 so that the AMTB address 2310 indicates the AMTB 2400b.

Here, the reason why the address map information is stored in the different new AMTB 2400b created without direct overwriting of the address map information 2210a at changing of the address map information in the AMTB 2400a, will be described below.

As described above, the management data is cached in the cache memory area. The AMTB 2400 created one after another along with changing of the address map information is stored as a dirty block (horizontal-striped portion) in a cache segment 2600, on a write-once basis. The AMTD 2300 having the AMTB address changed, results in a dirty block (horizontal-striped portion) in a cache segment 2500. As a result, the dirty block tends to gather in local cache segments in the cache memory area. Generally, in cache memory management, localization of the dirty block enables reduction of the number of times of data transfer processing between the storage controller 30 and the final storage device 40 or 41 at destaging. If a method of overwriting the AMTB 2400 is adopted, in a case where a request for writing of the user data is made to a random logical address, the dirty block of the AMTB 2400 is scattered on a large number of cache segments. Thus, an increase is made in the number of times of data transfer processing between the storage controller 30 and the final storage device 40 or 41 at destaging, so that the processing load of the CPU 33 increases.

Next, the processing operation in the information system 1B according to the present embodiment will be described.

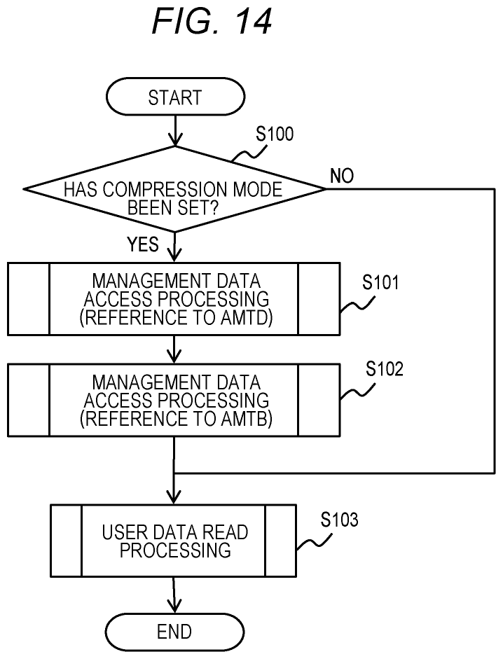

FIG. 14 is a flowchart of read command processing according to the embodiment.

The read command processing is performed when the storage system 20 receives the read command from the host computing machine 10.

When receiving the read command from the host computing machine 10, the CPU 33 determines whether the compression mode has been set (S100). In a case where the compression mode has not been set (S100: NO), the CPU 33 causes the processing to proceeds to step S103.

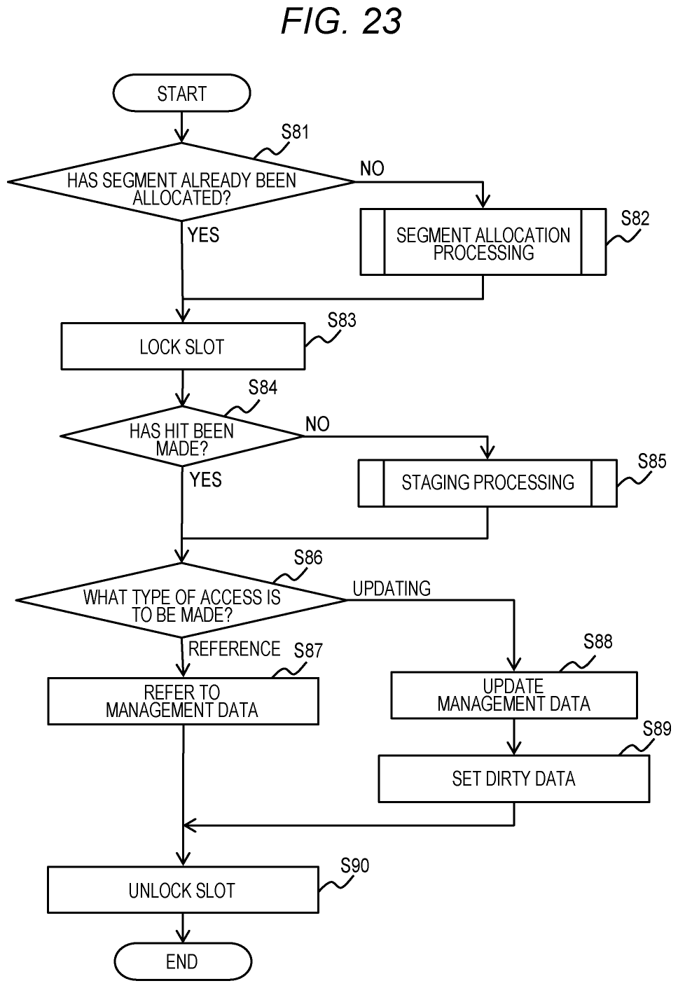

Meanwhile, in a case where the compression mode has been set (S100: YES), the CPU 33 performs reference to the AMTD 2300 with management data access processing (refer to FIG. 23) (S101). Specifically, from address X on the plain logical volume specified by the read command, the CPU 33 specifies the save destination address of the management data of the AMTD 2300 corresponding to address X, and acquires the management data from the AMTD 2300.

Next, the CPU 33 performs reference to the AMTB 2400 with management data access processing (refer to FIG. 23) (S102), and then causes the processing to proceed to step S103. Specifically, the CPU 33 specifies the save destination address of the management data of the AMTB 2400 from the management data acquired from the AMTD 2300, and acquires the management data from the AMTB 2400 (step S102).

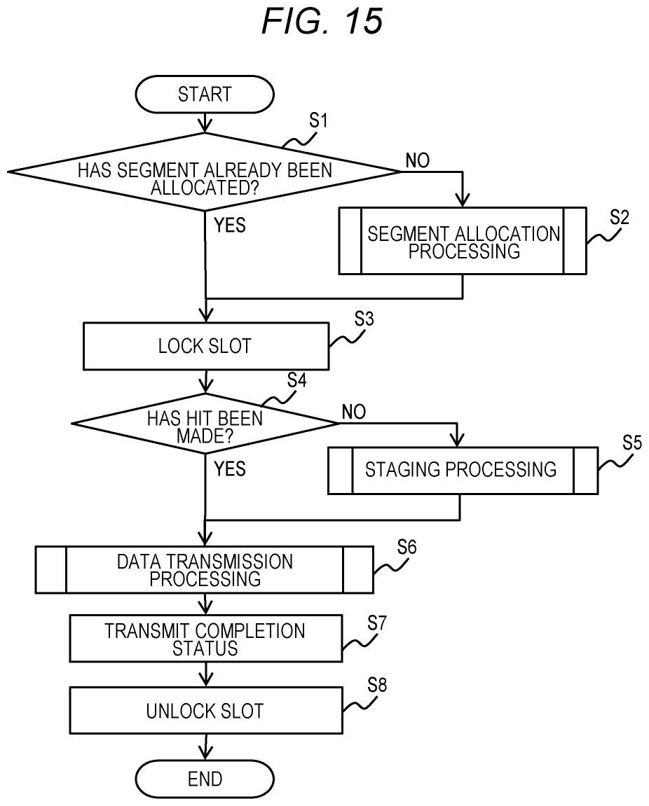

At step S103, in the case where the compression mode has not been set, the CPU 33 specifies address Y on the logical volume from the read command. Meanwhile, in the case where the compression mode has been set, the CPU 33 specifies address Y on the compressed logical volume from the management data of the AMTB 2400 acquired (front position and data length), and then performs user data read processing to address Y specified (refer to FIG. 15) (step S103).

Next, the user data read processing (step S103 of FIG. 14) will be described.

FIG. 15 is a flowchart of the user data read processing according to the embodiment.

First, the CPU 33 of the storage controller 30 determines whether the cache segment corresponding to the logical block address of the logical volume of the user data to be read (hereinafter, referred to as a read address) has already been allocated (step S1). Specifically, the CPU 33 converts the logical block address into a set of the slot ID and the in-slot relative address, and refers to the SGCT pointer 110f of the SLCT 110 with the slot ID 110d storing the slot ID acquired by the conversion. In a case where the SGCT pointer 110f has an invalid value (e.g., NULL), the CPU 33 determines that no cache segment has been allocated. Meanwhile, in a case where the SGCT pointer 110f includes a valid value, at least one cache segment should have been allocated. Thus, the CPU 33 verifies whether the cache segment has been allocated to the position in the slot specified by the in-slot relative address, along the pointer of the SGCT pointer 110f. Specifically, verification of whether the SGCT 120 having the segment ID 120b storing the segment ID identical to a result acquired by “the in-slot relative address=128” (integer value) is present, enables determination of whether the cache segment has been allocated to the read address. Here, because the calculation of “the in-slot relative address=128” results in acquisition of any integer value of 0 to 3, it can be found that the in-slot relative address corresponds to the cache segment given the segment ID with any of 0 to 3.

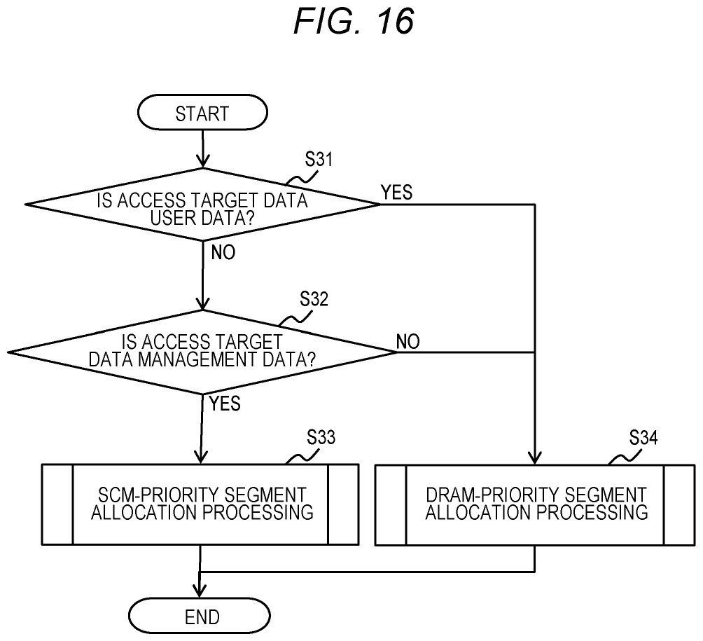

As a result, in a case where the cache segment has already been allocated (step S1: YES), the CPU 33 causes the processing to proceed to step S3. In a case where no cache segment has been allocated (step S1: NO), the CPU 33 performs segment allocation processing (refer to FIG. 16) (step S2), and then causes the processing to proceed to step S3. In the segment allocation processing, either the cache segment of the SCM 32 or the cache segment of the DRAM 34 is allocated in accordance with the type of data to be cached.

At step S3, the CPU 33 locks the slot including the cache segment corresponding to the read address. Here, the locking is intended for excluding another process of the CPU 33 so that the state of the slot is unchanged. Specifically, the CPU 33 turns ON (e.g., 1) the bit indicating “Being locked” stored in the slot status 110e of the SLCT 110 corresponding to the slot including the cache segment, to indicate that the slot has been locked.

Subsequently, the CPU 33 determines whether the user data to be read has been stored in the cache segment, namely, whether cache hit has been made (step S4). Specifically, the CPU 33 checks the staging bit map 120e and the dirty bit map 120f of the SGCT 120 corresponding to the cache segment to be read. If, for all blocks to be read, either the bit of the staging bit map 120e or the bit of the dirty bit map 120f corresponding to each block is ON (e.g., 1), the CPU 33 determines that the cache hit has been made. Meanwhile, in a case where at least one block in which both of the respective bits corresponding to the dirty bit map 120f and the staging bit map 120e are OFF (e.g., 0) is present in the range to be read, the CPU 33 determines that cache miss has been made.

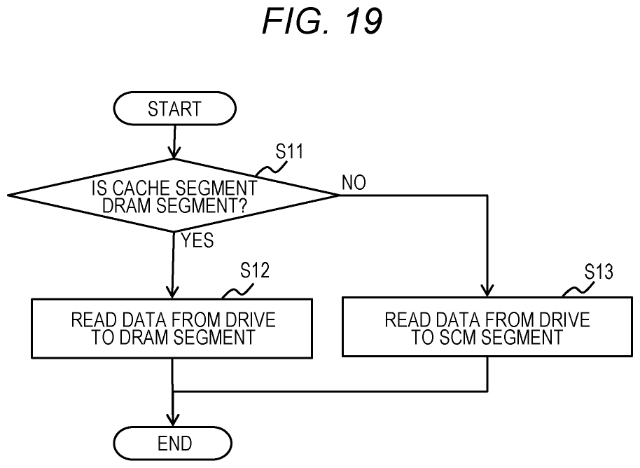

As a result, for the cache hit (step S4: YES), the CPU 33 causes the processing to proceed to step S6. Meanwhile, for the cache miss (step S4: NO), the CPU 33 performs staging processing (refer to FIG. 19) (step S5), and then causes the processing to proceed to step S6. In the staging processing, the data is read from the drive (HDD40 or SSD 41) to the cache segment 325 or 343. Completion of the staging processing results in a state in which the data to be read is stored in the cache segment 325 or 343.

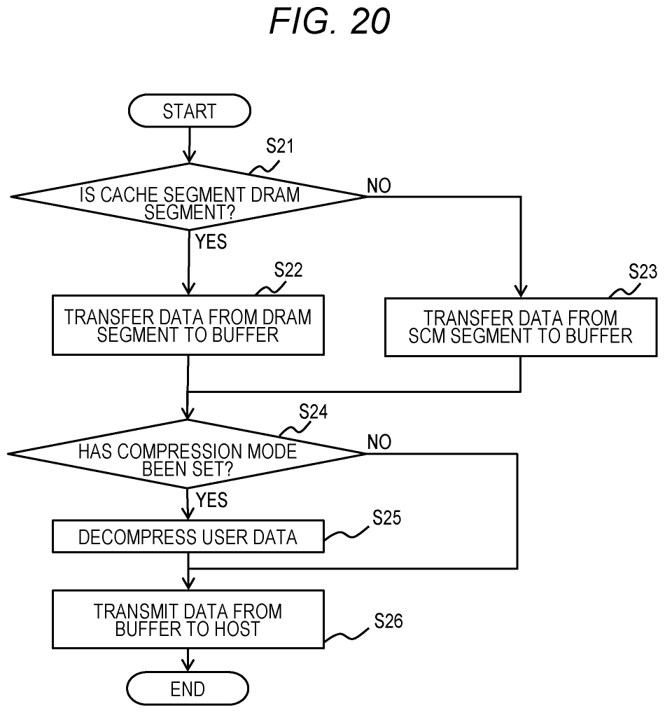

At step S6, the CPU 33 performs data transmission processing in which the data stored in the cache segment is transmitted to the host computing machine 10 (refer to FIG. 20).

Subsequently, the CPU 33 transmits completion status to the host computing machine 10 (step S7). Specifically, in a case where the read processing has not been completed correctly because of an error, the CPU 33 returns error status (e.g., CHECK CONDITION). Meanwhile, in a case where the read processing has been completed correctly, the CPU 33 returns correct status (GOOD).

After that, the CPU 33 unlocks the locked slot, namely, turns OFF the bit indicating “Being locked” stored in the slot status 110e of the SLCT 110 (step S8) so that the state of the slot is changeable. Then, the CPU 33 finishes the user data read processing.

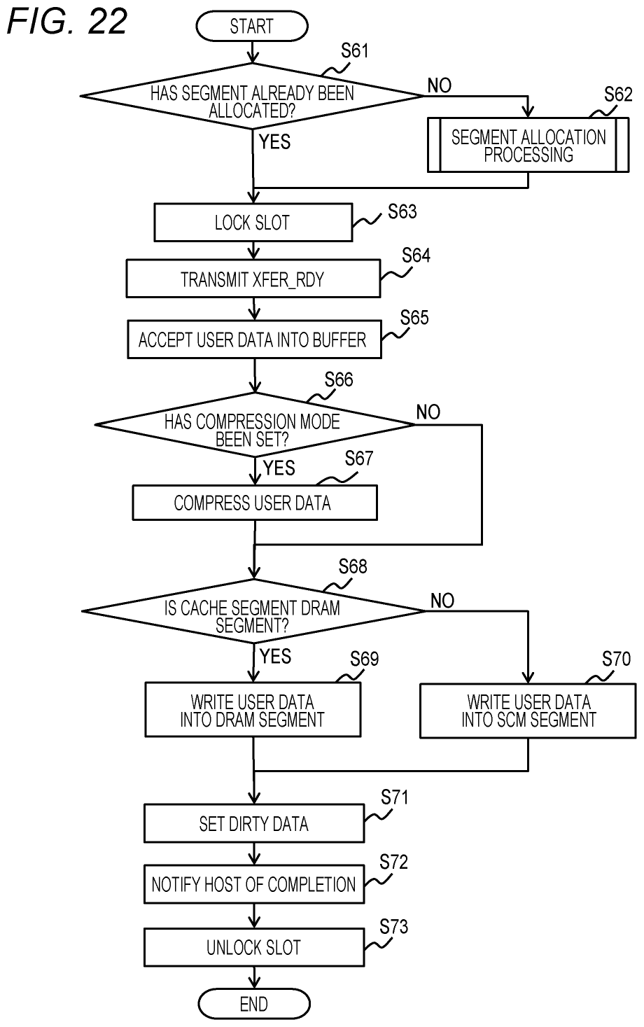

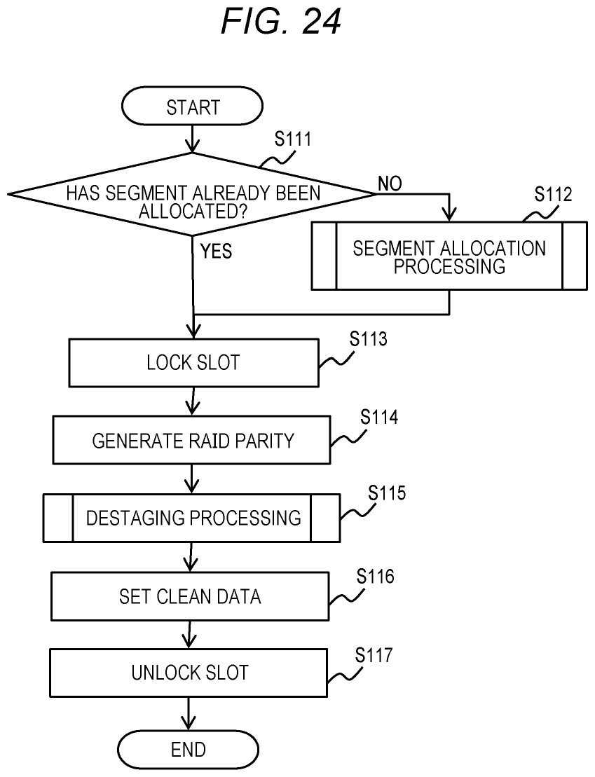

Next, the segment allocation processing (step S2 of FIG. 15) will be described. Note that the segment allocation processing corresponds to the processing at step S62 of FIG. 22, the processing at step S82 of FIG. 23, and the processing at step S112 of FIG. 24, to be described later.

FIG. 16 is a flowchart of the segment allocation processing according to the embodiment.

In the segment allocation processing, the CPU 33 allocates the cache segment (SCM segment) 325 of the SCM 32 or the cache segment (DRAM segment) 343 of the DRAM 34 to the data to be cached, in accordance with the type of the data (characteristic of the data).

Here, an exemplary determination criterion at selection of the memory type of the cache segment to be allocated to the data, namely, at selection of the SCM 32 or the DRAM 34, will be described. Characteristically, the SCM 32 is lower in access performance than the DRAM 34, but is lower in cost than the DRAM 34. Thus, according to the present embodiment, control is performed such that the cache segment with the DRAM 34 is selected for the data suitable to the characteristics of the DRAM 34 (data requiring high performance) and the cache segment with the SCM 32 is selected for the data suitable to the characteristics of the SCM 32 (data requiring no high performance, for example, data large in amount to be cached). Specifically, the memory type of the cache segment to be allocated is selected on the basis of the following criterion.

(a) In a case where the data to be cached is the user data requiring high throughput, the CPU 33 selects the DRAM 34 preferentially. Storage of such data into the cache segment of the SCM 32 causes the storage system 20 to deteriorate in performance. Therefore, preferably, the DRAM 34 is preferentially selected to the user data. Here, the preferential selection of the DRAM 34 means, for example, that the DRAM 34 is selected as the allocation destination in a case where the cache segment can be secured in the DRAM 34.

(b) In a case where the data to be cached has a unit of access that is small, the CPU 33 selects the SCM 32 preferentially. For example, for the management data, generally, one piece of data has a size of 8 B or 16 B. Thus, the management data is lower in required throughput than the user data. Preferably, the management data is cached in the SCM 32 low in cost. The reason is that, because the SCM 32 enables a larger-capacity cache segment at the same cost than the DRAM 34, an increase is made in the cacheable volume of data of the management data and a reduction is made in the frequency of reading of the management data on the drive 40 or 41, resulting in an effect that the storage system 20 improves in response performance.

(c) In a case where the data to be cached is different from the above pieces of data, the CPU 33 selects the DRAM 34 preferentially. First, the CPU 33 determines whether the data to be accessed (access target data) is the user data (step S31). In a case where the result of the determination is true (step S31: YES), the CPU 33 causes the processing to proceed to step S34. Meanwhile, in a case where the result is false (step S31: NO), the CPU 33 causes the processing to proceed to step S32.

At step S32, the CPU 33 determines whether the access target data is the management data. In a case where the result of the determination is true (step S32: YES), the CPU 33 causes the processing to proceed to step S33. Meanwhile, in a case where the result is false (step S32: NO), the CPU 33 causes the processing to proceed to step S34.

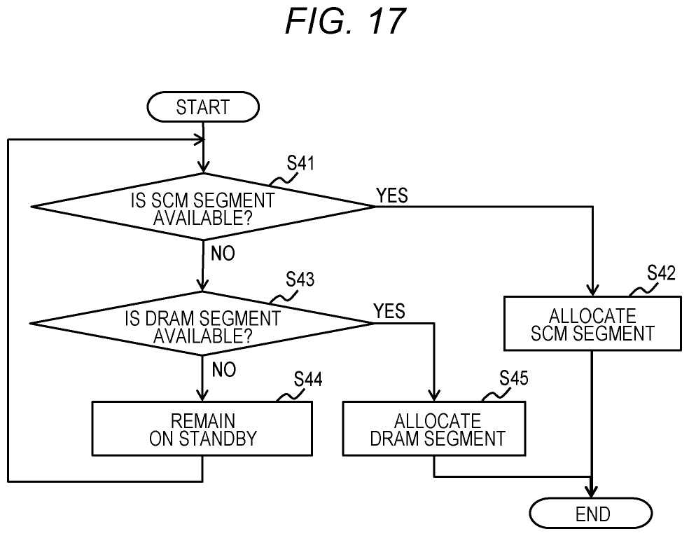

At step S33, the CPU 33 performs SCM-priority segment allocation processing in which the cache segment 325 of the SCM 32 is allocated preferentially (refer to FIG. 17), and then finishes the segment allocation processing.

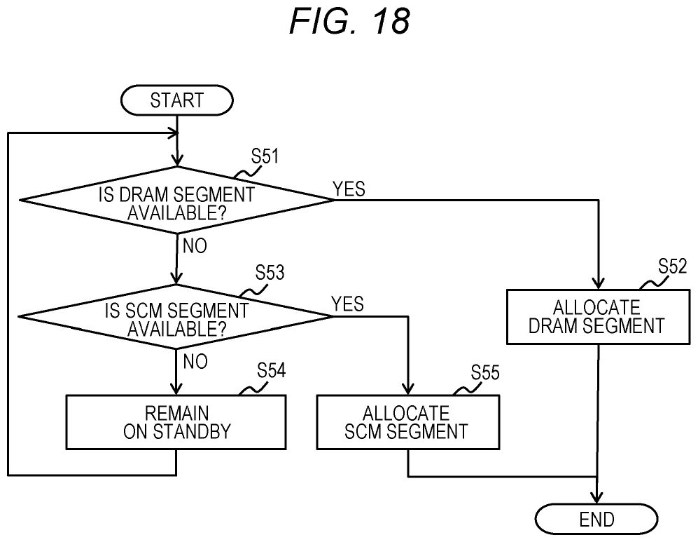

At step S34, the CPU 33 performs DRAM-priority segment allocation processing in which the cache segment 343 of the DRAM 34 is allocated preferentially (refer to FIG. 18), and then finishes the segment allocation processing.

Completion of the segment allocation processing results in allocation of the cache segment of either the SCM 32 or the DRAM 34 to the access target data.

Next, the SCM-priority segment allocation processing (step S33 of FIG. 16) will be described.

FIG. 17 is a flowchart of the SCM-priority segment allocation processing according to the embodiment.

First, the CPU 33 determines whether the available cache segment 325 of the SCM 32 is present (step S41). Here, the available cache segment 325 of the SCM 32 is the cache segment 325 that is free or clean and unlocked. Note that the determination of whether the available cache segment 325 of the SCM 32 is present can be made with reference to the SCM free queue 200 or the SGCT 120.

In a case where the result of the determination is true (step S41: YES), the CPU 33 causes the processing to proceed to step 42. Meanwhile, in a case where the result is false (step S41: NO), the CPU 33 causes the processing to proceed to step S43.

At step S42, the CPU 33 performs allocation of the cache segment of the SCM 32 (SCM segment allocation). Here, in a case where the clean cache segment 325 is allocated, the CPU 33 separates the cache segment 325 from the SCM free queue 200 and the cache directory 100 so that the cache segment 325 is made to the free segment. Then, the CPU 33 performs the allocation.

In the SCM segment allocation, first, the CPU 33 sets the segment ID and the memory type (here, SCM) corresponding to the secured cache segment, to the segment ID 120b and the memory type 120c of the SGCT 120. Next, the CPU 33 sets the pointer to the SGCT 120 of the cache segment, to the SGCT pointer 110f of the SLCT 110 corresponding to the slot including the cache segment 325. If the corresponding SLCT 110 is not in connection with the cache directory 100, the CPU 33 first sets the content of the SLCT 110. Then, the CPU 33 connects the SLCT 110 to the cache directory 100, and then connects the SGCT 120 to the SLCT 110. If the SLCT 110 is already in connection with another SGCT 120 different from the SGCT 120 corresponding to the secured cache segment 325, the CPU 33 connects the SGCT 120 of the secured cache segment 325 to the SGCT 120 at the end connected to the SLCT 110. Note that, after the SCM segment allocation finishes, the SCM-priority segment allocation processing finishes.

At step S43, the CPU 33 determines whether the available cache segment 343 of the DRAM 34 is present. In a case where the result of the determination is true (step S43: YES), the CPU 33 causes the processing to proceed to step S45. Meanwhile, in a case where the result is false (step S43: NO), the CPU 33 remains on standby until either of the cache segments 325 and 343 is made available (step S44), and then causes the processing to proceed to step S41.

At step S45, the CPU 33 performs allocation of the cache segment of the DRAM 34 (DRAM segment allocation). Although the cache segment 325 of the SCM 32 is allocated in the SCM segment allocation at step S42, the cache segment 343 of the DRAM 34 is allocated in the DRAM segment allocation. After the DRAM segment allocation finishes, the SCM-priority segment allocation processing finishes.

In the SCM-priority segment allocation processing, the cache segment 325 of the SCM 32 is allocated preferentially.

Next, the DRAM-priority segment allocation processing (step S34 of FIG. 16) will be described.

FIG. 18 is a flowchart of the DRAM-priority segment allocation processing according to the embodiment.

The DRAM-priority segment allocation processing results from replacement of the cache segment 325 of the SCM 32 in the SCM-priority segment allocation processing illustrated in FIG. 17, with the cache segment 343 of the DRAM 34. Thus, the description will be simplified herein.

First, the CPU 33 determines whether the available cache segment 343 of the DRAM 34 is present (step S51). In a case where the result of the determination is true (step S51: YES), the CPU 33 causes the processing to proceed to step S52. Meanwhile, in a case where the result is false (step S51: NO), the CPU 33 causes the processing to proceed to step S53.

At step S52, the CPU 33 performs DRAM segment allocation. The DRAM segment allocation is similar to the processing at step S45 of FIG. 17. After the DRAM segment allocation finishes, the DRAM-priority segment allocation processing finishes.

At step S53, the CPU 33 determines whether the available SCM segment 325 is present. In a case where the result of the determination is true (step S53: YES), the CPU 33 causes the processing to proceed to step S55. Meanwhile, in a case where the result is false (step S53: NO), the CPU 33 remains on standby until either of the cache segments 325 and 343 is made available (step S54), and then causes the processing to proceed to step S51.

At step S55, the CPU 33 performs SCM segment allocation. The SCM segment allocation is similar to the processing at step S42 of FIG. 17. After the SCM segment allocation finishes, the DRAM-priority segment allocation processing finishes.

In the DRAM-priority segment allocation processing, the DRAM segment 343 is allocated preferentially.

Next, the staging processing (step S5 of FIG. 15) will be described.

FIG. 19 is a flowchart of the staging processing according to the embodiment.

First, the CPU 33 checks the type of memory of the cache segment corresponding to the read address, to determine whether the cache segment is the DRAM segment 343 (step S11). Here, the type of the memory to which the cache segment belongs can be specified with reference to the memory type 120c of the corresponding SGCT 120.

As a result, in a case where the cache segment is the DRAM segment 343 (step S11: YES), the CPU 33 causes the processing to proceed to step S12. Meanwhile, in a case where the cache segment is not the DRAM segment 343 (step S11: NO), the CPU 33 causes the processing to proceed to step S13.

At step S12, the CPU 33 reads the data to be read (staging target) from the drive (HDD 40 or SSD 41), stores the data in the DRAM segment 343, and finishes the staging processing.

At step S13, the CPU 33 reads the data to be read (staging target) from the drive (HDD 40 or SSD 41), stores the data in the SCM segment 325, and finishes the staging processing.

The staging processing enables proper reading of the data to be read to the allocated cache segment.

Next, the data transmission processing (step S6 of FIG. 15) will be described.

FIG. 20 is a flowchart of the data transmission processing according to the embodiment.

First, the CPU 33 checks the type of the memory (cache memory) to which the cache segment corresponding to the read address belongs, to determine whether the cache segment is the DRAM segment 343 (step S21). Here, the type of the memory to which the cache segment belongs can be specified with reference to the memory type 120c of the SGCT 120 corresponding to the cache segment.

As a result, in a case where the cache segment is the DRAM segment 343 (step S21: YES), the CPU 33 causes the processing to proceed to step S22. Meanwhile, in a case where the cache segment is not the DRAM segment 343 (step S21: NO), the CPU 33 causes the processing to proceed to step S23.

At step S22, the CPU 33 transfers the data to be read (transmission target) from the DRAM segment 343 to the user data buffer 342, and then causes the processing to proceed to step S24.

At step S23, the CPU 33 transfers the data to be read (transmission target) from the SCM segment 325 to the user data buffer 342, and then causes the processing to proceed to step S24.

At step S24, the CPU 33 checks whether the storage system 20 has been set in the compression mode. In a case where the storage system 20 is in the compression mode (step S24: YES), the CPU 33 causes the processing to proceed to step S25. Meanwhile, in a case where the storage system 20 has not been set in the compression mode (step S24: NO), the CPU 33 causes the processing to proceed to step S26.

At step S25, the CPU 33 decompresses the compressed user data on the user data buffer 342, resulting in decompression to the pre-compression user data (original size). After that, the processing proceeds to step S26.

At step S26, the CPU 33 transfers the user data on the user data buffer 342, to the host computing machine 10, and then finishes the data transmission processing.

The data transmission processing enables proper transmission of the user data to be read to the host computing machine 10.

Next, write command processing will be described.

FIG. 21 is a flowchart of the write command processing according to the embodiment.

The write command processing is performed when the storage system 20 receives the write command from the host computing machine 10.

When the CPU 33 receives the write command from the host computing machine 10, the CPU 33 selects free address Y on the compressed logical volume, and performs user data write processing for writing the data to be written (write data) corresponding to the write command into the address (refer to FIG. 22) (step S104).

Next, the CPU 33 determines whether the storage system 20 has been set in the compression mode (S105). In a case where the storage system 20 has not been set in the compression mode (S105: NO), the CPU 33 finishes the write command processing. Meanwhile, in a case where the storage system 20 has been set in the compression mode (S105: YES), the CPU 33 causes the processing to proceed to step S106.

At step S106, the CPU 33 performs reference to the AMID 2300 with the management data access processing (refer to FIG. 23) (S106). Specifically, from address X on the plain logical volume specified by the read command, the CPU 33 specifies the save destination address of the management data of the AMID 2300 corresponding to address X, and acquires the management data from the AMID 2300.

Next, the CPU 33 performs reference to the AMTB 2400 with the management data access processing (refer to FIG. 23) (S107), and then causes the processing to proceed to step S108. Specifically, the CPU 33 specifies the save destination address of the management data of the AMTB 2400 from the management data acquired from the AMID 2300, and acquires the management data from the AMTB 2400.

At step S108, the CPU 33 performs updating of the AMTB 2400 with the management data access processing (refer to FIG. 23). Specifically, the CPU 33 changes the management data of the AMTB 2400 to information for new association of address X with address Y (e.g., front position and data length).

Next, the CPU 33 performs updating of the AMID 2300 with the management data access processing (refer to FIG. 23) (S109), and then finishes the processing. Specifically, the CPU 33 changes the management data of the AMID 2300 to information indicating the save destination address of the management data of the AMTB 2400 updated at step S108, and then finishes the processing.

The write command processing enables proper storage of the write data, and enables, in the compression mode, proper updating of the management data corresponding to the write data.

Next, the user data write processing (step S104 of FIG. 21) will be described.

FIG. 22 is a flowchart of the user data write processing according to the embodiment.

The CPU 33 of the storage controller 30 determines whether the cache segment corresponding to the logical block address of the logical volume for writing of the user data (hereinafter, referred to as a write address) has already been allocated (step S61). The processing is similar to a processing step in the user data read processing (S1 of FIG. 15), and thus the detailed description thereof will be omitted.

As a result, in a case where the cache segment has already been allocated (step S61: YES), the processing proceeds to step S63. Meanwhile, in a case where no cache segment has been allocated (step S61: NO), the segment allocation processing (refer to FIG. 16) is performed (step S62), and then the processing proceeds to step S63. In the segment allocation processing, a cache segment is allocated from the DRAM 34 or the SCM 32 to the write address. Note that, for securing of reliability with redundancy of the written data, two cache segments may be allocated.

At step S63, the CPU 33 locks the slot including the cache segment corresponding to the write address. Specifically, the CPU 33 turns ON the bit indicating “Being locked” in the slot status 110e of the SLCT 110 of the slot including the cache segment, to indicate that the slot has been locked.

Subsequently, the CPU 33 transmits, for example, XFER_RDY to the host computing machine 10, so that the host computing machine 10 is notified that preparation for data acceptance has been made (step S64). In accordance with the notification, the host computing machine 10 transmits the user data.

Next, the CPU 33 receives the user data transmitted from the host computing machine 10, and accepts the user data into the user data buffer 342 (step S65).

Subsequently, the CPU 33 determines whether the storage system 20 has been set in the compression mode (step S66). In a case where the storage system 20 has been set in the compression mode (step S66: YES), the CPU 33 causes the processing to proceed to step S67. Meanwhile, in a case where the storage system 20 has not been set in the compression mode (step S66: NO), the CPU 33 causes the processing to proceed to step S68.

At step S67, the CPU 33 compresses the user data on the user data buffer 342 for conversion to compressed user data (smaller in size than the original), and then causes the processing to proceed to step S68.

At step S68, the CPU 33 determines whether the allocated cache segment is the DRAM segment 343. As a result, in a case where the allocated cache segment is the DRAM segment 343 (step S68: YES), the CPU 33 writes the user data into the DRAM segment 343 (step S69), and then causes the processing to proceed to step S71. Meanwhile, in a case where the allocated cache segment is the SCM segment 325 (step S68: NO), the CPU 33 writes the user data into the SCM segment 325 (step S70), and then causes the processing to proceed to step S71.

At step S71, the CPU 33 sets the written data as the dirty data. That is the CPU 33 sets, at ON, the bit corresponding to the block having the data written, in the dirty bit map 120f of the SGCT 120 corresponding to the written cache segment.

Subsequently, the CPU 33 transmits completion status to the host computing machine 10 (step S72). That is, in a case where the write processing has not been completed correctly because of an error, the CPU 33 returns error status (e.g., CHECK CONDITION). Meanwhile, in a case where the write processing has been completed correctly, the CPU 33 returns correct status (GOOD).

Subsequently, the CPU 33 unlocks the locked slot (step S73) so that the state of the slot is changeable. Then, the CPU 33 finishes the user data write processing.

Next, the management data access processing (at S101 and S102 of FIGS. 14 and S106 to S109 of FIG. 21) will be described.

FIG. 23 is a flowchart of the management data access processing according to the embodiment.

The management data access processing includes processing of referring to the management data (management data reference processing) and processing of updating the management data (management data update processing). The processing to be performed varies between the management data reference processing and the management data update processing.

For example, at reception of the read command with the storage system 20 set in the compression mode, the management data reference processing is performed for reference to the read address on the compressed logical volume (front position and data length) associated with the read address on the plain logical volume specified by the read command (S101 of FIG. 12).

Meanwhile, for example, at reception of the write command with the storage system 20 set in the compression mode, the management data update processing is performed for new association of the write address on the plain logical volume specified by the write command with the write address on the compressed logical volume (front position and data length) (S108 of FIG. 21).

First, the CPU 33 specifies the address on the final storage device 40 or 41 storing the management data to be accessed (hereinafter, referred to as a management data address), and determines whether the cache segment has already been allocated to the management data address (step S81). The processing is similar to a processing step in the user data read processing (S1 of FIG. 15), and thus the detailed description thereof will be omitted. Note that the management data address is, for example, the address of the management data in the AMID 2300 or the address of the management data in the AMTB 2400.

As a result, in a case where the cache segment has already been allocated (step S81: YES), the CPU 33 causes the processing to proceed to step S83. Meanwhile, in a case where no cache segment has been allocated (step S81: NO), the CPU 33 performs the segment allocation processing (refer to FIG. 16) (step S82), and then causes the processing to proceed to step S83.

At step S83, the CPU 33 locks the slot including the cache segment corresponding to the management data address. Specifically, the CPU 33 turns ON the bit indicating “Being locked” in the slot status 110e of the SLCT 110 of the slot including the cache segment, to indicate that the slot has been locked.

Subsequently, the CPU 33 determines whether the management data has been stored in the cache segment, namely, whether the cache hit has been made (step S84). Specifically, the CPU 33 checks the staging bit map 120e and the dirty bit map 120f of the SGCT 120 corresponding to the cache segment of the management data. If, for all blocks of the management data to be referred to, either the bit of the staging bit map 120e or the bit of the dirty bit map 120f corresponding to each block is ON, the CPU 33 determines that the cache hit has been made. Meanwhile, in a case where at least one block in which both of the respective bits corresponding to the dirty bit map 120f and the staging bit map 120e are OFF is present in the range to be referred to, the CPU 33 determines that the cache miss has been made.

As a result, for the cache hit (step S84: YES), the CPU 33 causes the processing to proceed to step S86. Meanwhile, for the cache miss (step S84: NO), the CPU 33 performs the staging processing (refer to FIG. 19) (step S85), and then causes the processing to proceed to step S86. In the staging processing, the management data is read from the drive (HDD 40 or SSD 41) to the cache segment 325 or 343. Completion of the staging processing results in a state in which the management data is stored in the cache segment 325 or 343.

Subsequently, the CPU 33 determines what type of access is to be made to the management data (reference or updating) (step S86). As a result, in a case where the type of access is “reference” (step S86: reference), the CPU 33 refers to the management data stored in the cache segment (step S87), and then causes the processing to proceed to step S90.

Meanwhile, in a case where the type of access is “updating” (step S86: updating), the CPU 33 updates the block of the management data on the cache segment (step S88). Subsequently, the CPU 33 sets the updated block as the dirty data (step S89), and then causes the processing to proceed to step S90. That is the CPU 33 sets, at ON, the bit corresponding to the updated block in the dirty bit map 120f of the SGCT 120 corresponding to the cache segment including the updated block, and then causes the processing to proceed to step S90.

At step S90, the CPU 33 unlocks the locked slot so that the state of the slot is changeable. Then, the CPU 33 finishes the management data access processing.

The management data access processing enables reference to the management data and updating of the management data.

Next, dirty data export processing will be described.

FIG. 24 is a flowchart of the dirty data export processing according to the embodiment.

The dirty data export processing includes selecting the data dirty in the cache area of the memory on the basis of the Least Recently Used (LRU) algorithm and exporting the data to the final storage device, resulting in cleaning. Cleaning of the data enables the cache segment occupied by the data, to be free (unallocated) reliably from the cache area. The dirty data export processing is performed, for example, in a case where the free cache segment is insufficient for caching of new data in the memory. Preferably, the dirty data export processing is performed as background processing in a case where the CPU 33 of the storage system 20 is low in activity rate. This is because performance of the dirty data export processing after detection of a shortage of the free cache segment with the read/write command from the host computing machine 10 as a trigger, causes a drop in response performance by the amount of time necessary for export of the dirty data in the processing.

For prevention of data loss due to a device failure, the user data or the management data to be saved in the final storage device 40 or 41 may be subjected to redundancy based on the technology of Redundant Arrays of Independent Disks (RAID) and then may be recorded on the device. For example, in a case where the number of final storage devices is N, the data to be exported is uniformly distributed and recorded onto (N-1) number of final storage devices. Parity created by calculation of the exclusive disjunction of the data to be exported is recorded on the remaining one final storage device. This arrangement enables data recovery even when one of the N number of final storage devices fails. For example, when the following expression is satisfied: N=4, pieces of data D1, D2, and D3 equal in size are recorded on three devices, and parity P calculated by the following expression: P=D1+D2+D3 (+ represents exclusive disjunction) is recorded on the remaining one device. In a case where the device having D2 recorded fails, use of the property of the following expression: P+D1+D3=D2 enables recovery of D2. For such management, the CPU 33 uses the cache segment to store the parity in the cache memory area, temporarily.

In FIG. 24, first, the CPU 33 determines whether the cache segment for storage of the parity of the data to be exported (export target data) to the final storage device 40 or 41 has already been allocated (step S111). The processing is similar to a processing step in the user data read processing (S1 of FIG. 15), and thus the detailed description thereof will be omitted.

As a result, in a case where the cache segment has already been allocated (step S111: YES), the processing proceeds to step S113. Meanwhile, in a case where no cache segment has been allocated (step S111: NO), the segment allocation processing (refer to FIG. 16) is performed (step S112). Then, the processing proceeds to step S113. In the segment allocation processing, a cache segment is allocated from the DRAM 34 or the SCM 32 to the recording destination address of the parity. According to the present embodiment, the cache segment is allocated to the parity, similarly to the user data. Note that, for securing of reliability with redundancy of the parity, two cache segments may be allocated.

At step S113, the CPU 33 locks the slot including the cache segment for storage of the parity. Specifically, the CPU 33 turns ON the bit indicating “Being locked” in the slot status 110e of the SLCT 110 of the slot including the cache segment, to indicate that the slot has been locked.

Subsequently, the CPU 33 generates the parity from the export target data, and stores the parity in the already allocated segment (step S114).

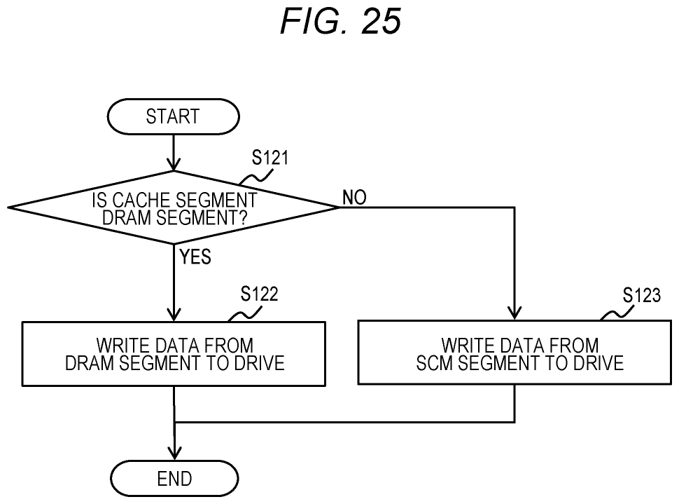

Subsequently, the CPU 33 performs destaging processing (refer to FIG. 25) to the export target data and the generated parity (step S115). The details of the destaging processing will be described later.

Subsequently, the CPU 33 sets, as the clean data, the export target data and the parity to which the destaging has been completed. That is the CPU 33 sets, at OFF, the bit corresponding to the block having the data written, in the dirty bit map 120f of the SGCT 120 corresponding to the cache segment (step S116).

Subsequently, the CPU 33 unlocks the locked slot (step S117) so that the state of the slot is changeable. Then, the CPU 33 finishes the dirty data export processing.

The dirty data export processing enables proper increase of the cache segment available for caching.

Next, the destaging processing (step S115 of FIG. 24) will be described.

FIG. 25 is a flowchart of the destaging processing according to the embodiment.

The destaging processing is performed to each of the export target data and the parity. First, the CPU 33 determines whether the cache segment allocated to the target data (export target data/generated parity) is the DRAM segment 343 (step S121).

As a result, in a case where the allocated cache segment is the DRAM segment 343 (step S121: YES), the CPU 33 reads the export target data/parity from the DRAM segment 343 and writes the export target data/parity in the storage device (HDD 40 or SSD 41) (step S122). Then, the CPU 33 finishes the destaging processing. Meanwhile, in a case where the allocated cache segment is the SCM segment 325 (step S121: NO), the CPU 33 reads the export target data/parity from the SCM segment 325 and writes the export target data/parity in the storage device (HDD 40 or SSD 41) (step S123). Then, the CPU 33 finishes the destaging processing.

The embodiment of the present invention has been described above. The embodiment is exemplary for description of the present invention, and thus the scope of the present invention is not limited to the embodiment. That is various modes may be made for the present invention.

For example, according to the embodiment, in a case where the DRAM segment 343 is unavailable to the user data, the SCM segment 325 is used if available (user data is stored in the SCM segment 325). However, the present embodiment is not limited to this. For example, in a case where the DRAM segment 343 is unavailable to the user data, the processing may be retained on standby until the DRAM segment 343 is made available. Specifically, for NO at step S51 in the DRAM-priority segment allocation processing of FIG. 18, the CPU 33 may cause the processing to proceed to step S54. At step S54, the CPU 33 may remain on standby until the DRAM segment 343 is made available. This arrangement enables reliable storage of the user data into the DRAM segment 343, so that the access performance to the user data can be retained high.

According to the embodiment, in a case where the SCM segment 325 is unavailable to the management data, the DRAM segment 343 is used if available (management data is stored in the DRAM segment 343). However, the present embodiment is not limited to this. For example, in a case where the SCM segment 325 is unavailable to the management data, the processing may be retained on standby until the SCM segment 325 is made available. Specifically, for NO at step S41 in the SCM-priority segment allocation processing of FIG. 17, the CPU 33 may cause the processing to proceed to step S44. At step S44, the CPU 33 may remain on standby until the SCM segment 325 is made available. This arrangement enables prevention of the management data from being stored in the DRAM segment 343, so that the free area of the DRAM 34 can be secured properly.

According to the embodiment, the user data is cached preferentially in the DRAM 34 and the management data is cached preferentially in the SCM 32. However, the definition of the destination of data in caching between the DRAM 34 and the SCM 32, is not limited to this. For example, partial user data characteristically requiring relatively high performance may be cached in the DRAM 34, and the other user data may be cached in the SCM 32. In other words, data characteristically requiring relatively high performance is required at least to be cached in a high-performance memory, and the other data characteristically requiring no high performance is required at least to be cached in a low-performance memory. For example, for determination of whether data characteristically requires relatively high performance, information allowing specification of such data (e.g., the name of data type, the LU of the storage destination, or the LBA of the LU) is required at least to be set previously. The determination is required at least to be made on the basis of the information.

According to the embodiment, the DRAM 34 and the SCM 32 have been given exemplarily as memories different in access performance. For example, a DRAM high in access performance and a DRAM low in access performance may be provided, and a memory for caching may be controlled, on the basis of the type of data, with the DRAMs. As memories different in access performance, two types of memories have been provided. However, three types or more of memories different in access performance may be provided. In this case, a memory for caching is controlled in accordance with the type of data.

What is claimed is:

1. A data management apparatus comprising:
a memory unit for caching of data according to input and output to a storage device; and a processor unit connected to the memory unit, wherein
the memory unit includes: a first type of memory high in access performance; and a second type of memory identical in a unit of access to the first type of memory, the second type of memory being lower in access performance than the first type of memory, and
the processor unit determines whether to perform caching to the first type of memory or the second type of memory, based on the data according to input and output to the storage device, and
caches the data into the first type of memory or the second type of memory, based on the determination.

2. The data management apparatus according to claim 1, wherein
the data according to input and output to the storage device includes: user data according to an input/output (I/O) command from a host computer; and management data for management of the user data, and
the processor unit determines to cache the user data into the first type of memory and to cache the management data into the second type of memory.

3. The data management apparatus according to claim 2, wherein
in a case where the first type of memory is not free when the processor unit caches the user data into the first type of memory, the processor unit determines to cache the user data into the second type of memory.

4. The data management apparatus according to claim 2, wherein
in a case where the first type of memory is not free when the processor unit caches the user data into the first type of memory, the processor unit caches the user data into the first type of memory after the processor unit remains on standby until the first type of memory is made free.

5. The data management apparatus according to claim 2, wherein
in a case where the second type of memory is not free when the processor unit caches the management data into the second type of memory, the processor unit determines to cache the management data into the first type of memory.

6. The data management apparatus according to claim 2, wherein
in a case where the second type of memory is not free when the processor unit caches the management data into the second type of memory, the processor unit caches the management data into the second type of memory after the processor unit remains on standby until the second type of memory is made free.

7. The data management apparatus according to claim 2, wherein
the management data includes address data allowing specification of an address for compression and storage of the user data into the storage device.

8. The data management apparatus according to claim 1, wherein
the first type of memory includes a dynamic random access memory (DRAM), and the second type of memory includes a storage class memory (SCM).

9. A data management method with a data management apparatus including a memory unit for caching of data according to input and output to a storage device, the memory unit including a first type of memory high in access performance and a second type of memory identical in a unit of access to the first type of memory, the second type of memory being lower in access performance than the first type of memory, the data management method comprising:
determining whether to perform caching to the first type of memory or the second type of memory, based on the data according to input and output to the storage device; and
storing the data into the first type of memory or the second type of memory, based on the determination.

10. A non-transitory computer-readable storage medium storing a data management program for causing a computer including a data management apparatus including a memory unit for caching of data according to input and output to a storage device and a processor unit connected to the memory unit, the memory unit including a first type of memory high in access performance and a second type of memory identical in a unit of access to the first type of memory, the second type of memory being lower in access performance than the first type of memory,
the data management program causing the computer to function as:
determining whether to perform caching to the first type of memory or the second type of memory, based on the data according to input and output to the storage device; and
storing the data into the first type of memory or the second type of memory, based on the determination.
